(19) United States
(12) Patent Application Publication
(10) Pub. No.: US 2026/0166914 A1
(43) Pub. Date: Jun. 18, 2026

(54) Backing Support for Mums and Garters

(71) Applicant: Brenda RIVERA, Cypress, TX (US)

(72) Inventor: Brenda RIVERA, Cypress, TX (US)

(21) Appl. No.: 19/415,360

(22) Filed: Dec. 10, 2025

Related U.S. Application Data
(60) Provisional application No. 63/734,075, filed on Dec. 14, 2024.

(51) Int. Cl. B44C 5/06; A44C 1/00

(52) U.S. Cl. CPC B44C 5/06; A44C 1/00

(57) ABSTRACT

The present disclosure provides a decorative support assembly for constructing a wearable item, comprising a backer board having a front surface and a rear surface, and a plurality of visual indicia printed or etched on the front surface of the backer board. The indicia include at least one of: (a) radially arranged tick marks; (b) alphanumeric quadrant labels; or (c) alignment zones marked for symmetrical placement of ribbons or embellishments. The assembly may include concentric circular guides, a detachable central portion, alignment apertures, and can be formed from various materials such as cardboard, cardstock, foam board, or plastic.

### CROSS-REFERENCE TO RELATED APPLICATIONS

This application claims priority to and benefit of U.S. Provisional Patent Application No. 63/734,075, titled “Backing Support for Mums and Garters,” filed on Dec. 14, 2024, which is hereby incorporated by reference in its entirety.

### FIELD OF INVENTION

The present disclosure relates to backing supports for decorative corsages and garters, and more particularly to guided backing supports with easy access features for homecoming mums and garters.

### BACKGROUND

Homecoming mums and garters are a cherished tradition in Texas and other parts of the United States. These decorative corsages and garters are worn by students during homecoming celebrations at high schools and colleges. The term “mum” is short for chrysanthemum, which was originally the primary flower used in these corsages. Over time, the word “mum” has come to refer to the entire decorative arrangement for girls, while “garter” is used for the version worn by boys.

A key component used in creating homecoming mums and garters is the backing support, also known as a mum backer. This support structure is typically made of cardboard or cardstock and serves as the foundation to which ribbons, flowers, and other decorative elements are attached. The backing support generally consists of two main parts—a crown backer for the top portion of the mum or garter, and a skirt backer for the bottom portion. The crown backer is often circular but may also be shaped like the state of Texas, a heart, or other designs. The skirt backer provides support for the cascading ribbons and decorations.

Existing backing supports present several challenges for mum makers. Positioning ribbon loops and tails evenly around the support can be difficult, often resulting in asymmetrical or unbalanced designs. Attaching decorative elements securely while maintaining a professional appearance is also problematic with current backers. Additionally, standard staplers are frequently too short to comfortably attach loops to the backer, which can lead to wrinkling of luster ribbon. Aligning the crown and skirt portions properly is another common issue that may require multiple attempts. For irregularly shaped backers, placement of flowers to maintain the intended shape while providing full coverage can be challenging.

Prior art patent documents related to floral arrangements and decorative corsages include the following:
U.S. Pat. No. 5,524,651 discloses an interchangeable decorative ornament comprising a plurality of holding members with openings for receiving a decorative element such as a scarf or ribbon. The holding members are spaced apart to allow the decorative element to be drawn through uninterrupted regions between them.
U.S. Pat. No. 5,658,621 describes a device for designing floral bouquets that includes a substrate with ornamental members positionable on its surface. The ornamental members may have design features depicting flowers or other decorative elements.
U.S. Pat. No. 5,853,827 presents a crown for use in floral arrangements, comprising a central dome with lateral edges and depending skirts. The crown includes primary guides for positioning decorative elements and a coding system to identify placement locations.
U.S. Patent Application Publication No. 2019/0104689 discloses a universal decoration apparatus system with multiple attachment mechanisms for securing decorative elements to various substrates without requiring modification of the substrate.
U.S. Patent Application Publication No. 2018/0049541 describes a floral attachment assembly comprising a pin assembly with multiple pins for engaging a floral arrangement and securing it to a garment when mated with a base.

These prior art documents demonstrate various approaches to creating and attaching decorative floral arrangements. However, there remains a need for improved backing supports that address the specific challenges faced by makers of homecoming mums and garters.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a decorative support assembly for constructing a wearable item is provided. The decorative support assembly includes a backer board having a front surface and a rear surface, and a plurality of visual indicia printed or etched on the front surface of the backer board for enabling repeatable and symmetrical placement of decorative elements. The indicia include at least one of: (a) radially arranged tick marks; (b) alphanumeric quadrant labels; or (c) alignment zones marked for symmetrical placement of ribbons or embellishments. The backer board includes a detachable central portion defined by a weakened boundary that provides a visual placeholder during layout and can be selectively removed to create an opening for attaching a central decorative element or retained for layered presentation.

According to other aspects of the present disclosure, the decorative support assembly may include one or more of the following features. The visual indicia may further include concentric circular guides for positioning decorative elements at varying radial distances from a center of the backer board, thereby providing instructional guidance for decorative placement. The weakened boundary may comprise a perforated line, a scored line, or a partially cut line. The decorative support assembly may further comprise a plurality of alignment apertures formed through the backer board for securing decorative elements or attaching additional layers. The alignment apertures may be configured to receive mechanical fasteners for coupling the backer board to a secondary backer board, enabling a modular multi-part construction. The backer board may be formed from a material selected from the group consisting of cardboard, cardstock, foam board, and plastic. The detachable central portion may remain partially attached to the backer board at one or more connection points to allow folding back of the central portion while maintaining structural integrity.

According to another aspect of the present disclosure, a modular decorative backer system for a wearable item is provided. The system includes a crown backer and a skirt backer, each comprising a generally planar base with a front face and a rear face, wherein the crown backer and skirt backer are functionally distinct components that promote ease of assembly and customization. The system also includes a plurality of alignment apertures formed through each backer. The crown backer is removably coupled to the skirt backer through at least two of the alignment apertures using mechanical fasteners, allowing decorative elements to be independently arranged, secured, and layered in stages. The crown backer includes a detachable central portion defined by a weakened boundary that can be selectively removed or retained, providing functional flexibility without additional parts.

According to other aspects of the present disclosure, the modular decorative backer system may include one or more of the following features. The crown backer may include visual indicia printed or etched on its front face for guiding placement of decorative elements, enabling repeatable and symmetrical decorative arrangements. The visual indicia may comprise at least one of radially arranged tick marks, alphanumeric quadrant labels, or alignment zones marked for symmetrical placement of ribbons, forming an instructional craft system. The visual indicia may further include concentric circular guides for positioning decorative elements at varying radial distances from a center of the crown backer. The detachable central portion may provide a visual placeholder during layout and can be selectively removed to create an opening for attaching a central decorative element or retained for layered presentation. The mechanical fasteners may comprise zip ties, twist ties, or string. The skirt backer may include additional alignment apertures for attaching cascading ribbons or decorations, enabling multi-layered decorative arrangements.

According to another aspect of the present disclosure, a decorative crafting backer is provided. The decorative crafting backer includes a planar board having a central portion and a peripheral portion. The central portion is defined by a weakened boundary and is selectively detachable from the peripheral portion to expose an opening, providing a visual placeholder during layout and offering user choice between removing the center for open designs or leaving it intact for layered presentation. The peripheral portion includes alignment indicia printed or etched on its surface for positioning decorative components in radial arrangement relative to the opening, enabling repeatable and symmetrical decorative placement.

According to other aspects of the present disclosure, the decorative crafting backer may include one or more of the following features. The alignment indicia may comprise radially arranged tick marks spaced at regular angular intervals around the peripheral portion, forming part of an instructional craft system. The alignment indicia may further comprise concentric circular guides for positioning decorative components at varying radial distances from the opening, providing instructional guidance for decorative placement. The weakened boundary may comprise a perforated line, a scored line, or a partially cut line. The decorative crafting backer may further comprise a plurality of alignment apertures formed through the peripheral portion for securing decorative components or attaching additional layers, enabling a modular multi-part construction. The alignment apertures may be configured to receive mechanical fasteners for coupling the decorative crafting backer to a secondary backer, allowing decorative elements to be independently arranged, secured, and layered in stages.

The foregoing general description of the illustrative embodiments and the following detailed description thereof are merely exemplary aspects of the teachings of this disclosure and are not restrictive.

### BRIEF DESCRIPTION OF THE DRAWINGS

FIG. 1 illustrates a front view of a decorative support assembly for constructing a wearable item, in accordance with one embodiment of the present invention.

FIG. 2 illustrates a front view of a crown backer with visual indicia, in accordance with one embodiment of the present invention.

FIG. 3 illustrates a front view of a skirt backer in a rectangular configuration, in accordance with one embodiment of the present invention.

FIG. 4 illustrates a front view of the crown backer during an assembly process, in accordance with one embodiment of the present invention.

FIG. 5 illustrates a front view of the crown backer with decorative articles attached, in accordance with one embodiment of the present invention.

FIG. 6 illustrates a front view of the skirt backer during an assembly process, in accordance with one embodiment of the present invention.

FIG. 7 illustrates a rear perspective view of the decorative support assembly during an attachment process, in accordance with one embodiment of the present invention.

FIG. 8 illustrates a rear view of the decorative support assembly with covers, in accordance with one embodiment of the present invention.

FIG. 9 illustrates a front view of the crown backer, in accordance with another embodiment of the present invention.

FIG. 10 illustrates a front view of the crown backer, in accordance with another embodiment of the present invention.

FIG. 11 illustrates a front view of the crown backer, in accordance with yet another embodiment of the present invention.

FIG. 12 illustrates a front view of a crown backer in a Texas shape, in accordance with one embodiment of the present invention.

FIG. 13 illustrates a front view of a skirt backer configured for use with the crown backer of FIG. 12, in accordance with one embodiment of the present invention.

FIG. 14 illustrates a top view of the crown backer of FIG. 12 during assembly, in accordance with one embodiment of the present invention.

FIG. 15 illustrates a front view of a heart-shaped crown backer, in accordance with one embodiment of the present invention.

FIG. 16 illustrates a top view of the heart-shaped crown backer of FIG. 15 during assembly, in accordance with one embodiment of the present invention.

FIG. 17 illustrates the heart-shaped crown backer of FIG. 15 in multiple sizes, in accordance with one embodiment of the present invention.

FIG. 18 illustrates a front view of a skirt backer configured for use with the heart-shaped crown backer of FIG. 15, in accordance with one embodiment of the present invention.

FIG. 19 illustrates front views of a circular crown backer in multiple sizes, in accordance with one embodiment of the present invention.

FIG. 20 illustrates a front view of a skirt backer configured for use with the crown backer of FIG. 19, in accordance with one embodiment of the present invention.

### DETAILED DESCRIPTION

The invention now will be described more fully hereinafter with reference to the accompanying drawings, in which embodiments of the invention are shown. This invention may however be embodied in many different forms and should not be construed as limited to the embodiments set forth herein. Rather, these embodiments are provided so that this invention will be thorough and complete, and will fully convey the scope of the invention to those skilled in the art.

It will be understood that when an element is referred to as being “on” another element, it can be directly on the other element or intervening elements may be present therebetween. As used herein, the term “and/or” includes any and all combinations of one or more of the associated listed items.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section.

It will be understood that the elements, components, regions, layers and sections depicted in the figures are not necessarily drawn to scale.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom,” “upper” or “top,” “left” or “right,” “above” or “below,” “front” or “rear,” may be used herein to describe one element's relationship to another element as illustrated in the Figures. It will be understood that relative terms are intended to encompass different orientations of the device in addition to the orientation depicted in the Figures.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present invention, and will not be interpreted in an idealized or overly formal sense unless expressly so defined herein.

Exemplary embodiments of the present invention are described herein with reference to idealized embodiments of the present invention. As such, variations from the shapes of the illustrations as a result, for example, of manufacturing techniques and/or tolerances, are to be expected. The numbers, ratios, percentages, and other values may include those that are ±5%, ±10%, ±25%, ±50%, ±75%, ±100%, ±200%, ±500%, or other ranges that do not detract from the spirit of the invention. The terms about, approximately, or substantially may include values known to those having ordinary skill in the art. If not known in the art, these terms may be considered to be in the range of up to ±5%, ±10%, or other value higher than these ranges commonly accepted by those having ordinary skill in the art for the variable disclosed. Thus, embodiments of the present invention should not be construed as limited to the particular shapes of regions illustrated herein but are to include deviations in shapes that result, for example, from manufacturing. The invention illustratively disclosed herein suitably may be practiced in the absence of any elements that are not specifically disclosed herein. All patents, patent applications and non-patent literature cited through this Specification are hereby incorporated by reference in their entireties. References cited in an Information Disclosure Statement should not be construed as an admission that the cited reference comes from an area that is analogous or directly applicable to the invention, but rather that the reference is being cited out of an abundance of caution.

The present invention provides a guided backer for homecoming mums. The guided backer indicates a decorative support assembly configured for constructing wearable items. This assembly may comprise a backer board having a front surface and a rear surface. The backer board may be formed from materials such as cardboard, cardstock, foam board, or plastic. The backer board may include a crown backer and/or a skirt backer.

In some cases, the front surface of the backer board includes a plurality of visual indicia. These visual indicia may be printed or etched onto the front surface to provide guidance for assembling decorative elements. The visual indicia may assist in positioning and aligning various components of the homecoming mum, enabling users to achieve symmetrical and balanced decorative arrangements. The visual indicia may include radially arranged tick marks extending from a center point towards the outer edge, serving as positioning guides for decorative elements at regular angular intervals around the backer. In some implementations, the radial lines may alternate between solid and dotted patterns in a systematic manner, with solid lines positioned at primary angular positions and dotted lines positioned at intermediate angular positions to help users distinguish between different placement positions and facilitate the creation of layered decorative arrangements.

The backer board may serve as a structural foundation for attaching decorative elements such as ribbons, flowers, and other embellishments. In some implementations, the backer board may include apertures for inserting floral stems or other decorative components, with a central aperture allowing for the insertion of floral stems or other central decorative elements. The support backer may also include a series of concentric circular guides positioned between the center and the outer perimeter to assist in positioning decorative elements at varying radial distances from the center of the backer board. These concentric circles may have different line styles such as stitched lines, solid lines, and dotted lines, with each type providing distinct visual cues for different layers or types of decorative elements.

In some implementations, the visual indicia described herein may alternatively be supplied through a separate stencil configured to overlay the front surface of the backer. The stencil may include cutouts, apertures, or line markings corresponding to the radial tick marks, concentric circular guides, quadrant labels, or alignment zones. When positioned over the backer, the stencil enables the user to trace the indicia, align decorative elements directly through the stencil openings, or use the stencil as a temporary placement guide. This stencil-based approach allows the same stencil to be used with multiple backer shapes and sizes.

Additionally, the backer board may incorporate alignment features to facilitate proper positioning of decorative elements or attachment to other components. These alignment features may work in conjunction with the visual indicia to enable symmetrical and balanced arrangement of decorative elements. In some cases, the visual indicia may include alphanumeric quadrant labels positioned around the perimeter of the backer, providing additional reference points for organizing and arranging decorative elements. The support backer may incorporate alignment zones marked for symmetrical placement of ribbons or embellishments, indicated by specific patterns or spacing of the radial and concentric guides.

The guided backer system may be designed to accommodate different sizes and shapes of homecoming mums. In some cases, the system may include separate components for the crown and skirt portions of the mum, allowing for modular assembly. The circular support backer may include inner slits or openings that allow for easy insertion of a standard stapler to attach ribbon loops and other decorative elements. These inner slits may be strategically positioned to provide access to areas of the backer that would otherwise be difficult to reach with conventional staplers, eliminating the need for specialized long-reach staplers. The arrangement of radial lines, concentric circles, and other visual indicia may create a systematic grid pattern that enables users to achieve symmetrical and balanced placement of decorative elements around the circular support structure.

In some embodiments, the radial lines, concentric guides, and spacing indicators used for circular backers may be implemented as part of a reusable stencil sized to fit over different circular diameters. The stencil may include through-cut lines or partial openings aligned with the solid and dotted tick-mark pattern, allowing users either to trace the pattern onto the backer or to align ribbon loops directly while the stencil is in position. The stencil may further include an opening corresponding to the detachable central portion or inner slits, permitting insertion of a standard stapler so that decorative elements may be secured while the stencil remains over the backer.

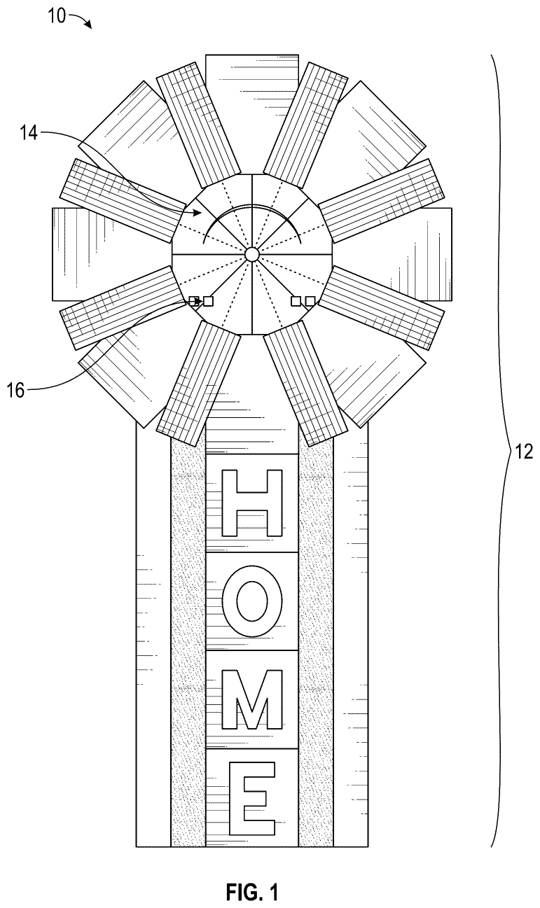

FIG. 1 shows a decorative support assembly 10 configured for constructing a wearable item 12, in accordance with one embodiment of the present invention. Decorative support assembly 10 serves as a structural foundation that facilitates the creation of decorative arrangements such as homecoming mums and garters. Wearable item 12 includes a complete decorative arrangement that results from the assembly process using decorative support assembly 10. Wearable item 12 is worn during special events such as homecoming celebrations, school functions, or other ceremonial occasions. Decorative support assembly 10 enables the creation of wearable item 12 through a modular approach that allows for customization and personalization based on individual preferences and design requirements.

Wearable item 12 displays a layered arrangement of decorative components that create visual depth and texture. Wearable item 12 incorporates ribbons, flowers, embellishments, and other ornamental elements that are systematically positioned using the guidance provided by decorative support assembly 10. Decorative support assembly 10 facilitates the creation of symmetrical patterns and balanced distributions of decorative elements throughout wearable item 12. Decorative support assembly 10 provides structural support for various decorative elements while maintaining the overall shape and integrity of the finished arrangement. Decorative support assembly 10 incorporates guidance features that assist users in achieving consistent and professional-looking results during the assembly process.

Decorative support assembly 10 includes a crown backer 14 that supports the upper portion of wearable item 12. Crown backer 14 is positioned at the top section of decorative support assembly 10 and provides a foundation for attaching various decorative elements such as ribbon loops, flowers, and ornamental embellishments. Crown backer 14 facilitates the creation of the main focal point of wearable item 12 by supporting decorative arrangements in a radial pattern around a central region.

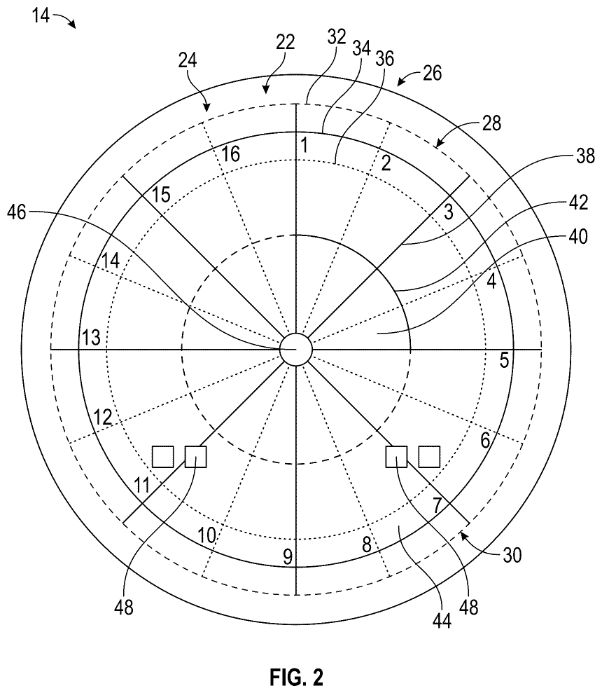

FIG. 2 shows a front view of crown backer 14, in accordance with one embodiment of the present invention. Crown backer 14 is formed in various shapes to accommodate different design preferences and thematic requirements. In some cases, crown backer 14 has a circular configuration. Crown backer 14 may also be manufactured in heart-shaped, Texas-shaped, butterfly-shaped, paw-shaped, horse-shaped, bow-shaped, and quadrilateral shapes to provide users with diverse design options for creating customized wearable items 12. Crown backer 14 may be manufactured from various materials to provide different structural properties and aesthetic characteristics. In some aspects, crown backer 14 is formed from cardboard or cardstock materials that offer sufficient rigidity for supporting decorative elements while remaining lightweight and easy to handle during assembly. Crown backer 14 may also be constructed from foam board materials, which provide enhanced thickness and dimensional stability compared to traditional cardboard options. Crown backer 14 is formed from foam board material with varying thicknesses and densities to provide lightweight yet rigid support for decorative arrangements. In some cases, foam board thicknesses range from 3/16 inch to ½ inch, with the core material comprising extruded polystyrene foam sandwiched between paper facings. The density of the foam core varies to affect the overall strength and weight of crown backer 14. In some cases, crown backer 14 is manufactured from plastic materials such as polystyrene, polypropylene, or polyethylene, which offer increased durability and moisture resistance. Crown backer 14 may be formed from corrugated plastic sheets that combine lightweight properties with enhanced structural strength. In some aspects, crown backer 14 is produced using chipboard or pressboard materials that provide a dense, smooth surface suitable for printing visual indicia 28.

Crown backer 14 may also be manufactured from composite materials that combine multiple layers of different substrates to achieve desired performance characteristics. In some cases, crown backer 14 incorporates fabric-backed materials where a textile layer is laminated to a rigid substrate to provide enhanced texture and appearance. Crown backer 14 may be formed from recycled materials or eco-friendly substrates to address environmental considerations while maintaining functional performance requirements. Crown backer 14 is manufactured using various methods to create visual indicia 28 and structural features. In some cases, digital printing techniques are employed to apply radial lines, concentric circles, and other alignment guides directly onto crown backer 14. Crown backer 14 is also produced using offset printing techniques for high-volume production, screen printing for applying thicker inks or specialized coatings, or laser etching or engraving to create precise and durable markings on the surface.

Crown backer 14 includes a crown planar base 22 having a front face 24 and a rear face 26. Crown planar base 22 provides a flat, stable surface for mounting decorative components and serves as the structural foundation for the upper portion of the decorative arrangement. Front face 24 includes various visual indicia 28 that assist users in positioning decorative elements during assembly. Rear face 26 is used for connecting crown backer 14 to other components of decorative support assembly 10.

With continued reference to FIG. 2, crown backer 14 includes visual indicia 28 that are printed or etched on front face 24 of crown backer 14 to provide systematic guidance for positioning decorative elements during assembly. Visual indicia 28 comprise various types of markings that enable repeatable and symmetrical placement of decorative components, facilitating consistent and professional-looking results across multiple assembly processes. Visual indicia 28 serve as reference points that assist users in achieving balanced distributions of decorative elements while maintaining the overall aesthetic integrity of the finished arrangement.

Visual indicia 28 include radially arranged tick marks that extend from a central region toward the outer perimeter of crown backer 14. The radially arranged tick marks are positioned at regular angular intervals around crown backer 14 to provide systematic placement guidance for decorative elements such as ribbon loops, flowers, and embellishments. In some cases, the radially arranged tick marks alternate between solid and dotted line patterns in a systematic manner, with solid lines positioned at primary angular positions and dotted lines positioned at intermediate angular positions to help users distinguish between different placement positions and facilitate the creation of layered decorative arrangements. This alternating pattern enables users to position different types or layers of decorative elements at distinct radial positions, with one type of decorative element aligned with solid tick marks and another type aligned with dotted tick marks, thereby creating multi-layered decorative arrangements with organized spacing and visual depth.

Visual indicia 28 include alphanumeric quadrant labels positioned around the perimeter of crown backer 14 to provide additional reference points for organizing and arranging decorative elements. The alphanumeric quadrant labels enable users to follow specific assembly instructions or create coordinated patterns by referencing particular labeled sections of crown backer 14. In some aspects, the alphanumeric quadrant labels are arranged in a systematic sequence that corresponds to assembly steps or decorative element types.

Visual indicia 28 include alignment zones marked for symmetrical placement of ribbons or embellishments. The alignment zones are indicated by specific patterns, spacing, or markings that define optimal placement areas for different types of decorative components. The alignment zones facilitate the creation of balanced and symmetrical decorative arrangements by providing clearly defined regions for positioning various decorative elements around crown backer 14. Visual indicia 28 incorporate color coding schemes that enhance user guidance through the use of different colors for various marking types. In some cases, the radially arranged tick marks utilize a color gradient system to indicate distance from the center, with tick marks closest to the center colored in cool tones and transitioning to warmer tones toward the outer edges. The color progression assists users in visually gauging the radial positioning of decorative elements without requiring precise measurements.

Visual indicia 28 include concentric circular guides 30 for positioning decorative elements at varying radial distances from a center of crown backer 14. Concentric circular guides 30 provide instructional guidance for decorative placement by establishing multiple reference rings that define specific radial zones around the central region of crown backer 14. Concentric circular guides 30 enable users to systematically position decorative elements at predetermined distances from the center, facilitating the creation of layered arrangements with consistent spacing and proportional relationships between different decorative components.

Concentric circular guides 30 include a first circular guide 32, a second circular guide 34, and a third circular guide 36. First circular guide 32 represents the outermost circular guide, while second circular guide 34 is positioned intermediate between first circular guide 32 and third circular guide 36.

Third circular guide 36 represents the innermost circular guide. Each of first circular guide 32, second circular guide 34, and third circular guide 36 is provided in different line styles such as solid, dashed, dotted, or other configurations to differentiate the guides from one another. Although three circular guides are shown, it is possible to provide at least one and more than one concentric circular guide, with the concentric circles designed with different line styles including at least two of solid lines, dotted lines, and dashed lines to make them easily distinguishable for mum makers as they position their different sets of loops.

Concentric circular guides 30 may be positioned at specific distances from the outer perimeter of crown backer 14 to optimize decorative element placement. In some aspects, the outermost concentric circular guide may be positioned at a distance of about 0.5 to 10 cm from the edge of crown backer 14, more preferably 1 to 9 cm, and even more preferably about 1.9 cm from the outer perimeter. The spacing between adjacent concentric circular guides 30 may range from about 0.01 to 10 cm, more preferably 0.05 to 3 cm, and even more preferably about 0.64 cm apart from one another. The specific spacing dimensions may vary depending on the overall size of crown backer 14, with larger backers accommodating proportionally increased spacing between concentric circular guides 30 to maintain optimal visual guidance for decorative element placement. The dimensional relationships between concentric circular guides 30 provide consistent reference points that scale appropriately with different crown backer 14 sizes while maintaining functional guidance capabilities for users during assembly operations.

Further, crown backer 14 includes quadrant guides 38 that divide crown planar base 22 into multiple sections for systematic placement of decorative elements. In some cases, crown planar base 22 is divided into sixteen quadrant guides 38, with each quadrant guide 38 being numbered to facilitate organized placement of decorative items during assembly. Quadrant guides 38 provide reference points that enable users to create symmetrical and balanced decorative arrangements around crown backer 14.

As further shown in FIG. 2, crown backer 14 includes a detachable central portion 40. Detachable central portion 40 is provided in a circular configuration and is positioned inside third circular guide 36. Detachable central portion 40 includes a weakened boundary 42 formed along a portion of detachable central portion 40. Weakened boundary 42 includes a perforated line, a scored line, or a partially cut line. The area surrounding detachable central portion 40, including concentric circular guides 30, is referred to as a peripheral portion 44. Weakened boundary 42 may be provided at the top, bottom, or sides. In one example, weakened boundary 42 is formed along the top side edge of detachable central portion 40 while leaving the upper portion and side portions intact. This configuration allows detachable central portion 40 to be folded back while maintaining structural integrity during assembly. Weakened boundary 42 is represented by a dashed line or cut line indicating where detachable central portion 40 can be separated or opened from the surrounding structure of crown backer 14.

Peripheral portion 44 surrounds detachable central portion 40 and encompasses the primary structural and guidance features of crown backer 14. Peripheral portion 44 includes the annular region of crown planar base 22 that extends from the outer boundary of detachable central portion 40 to the outer perimeter of crown backer 14. Peripheral portion 44 provides the main working area for positioning and securing decorative elements during assembly of wearable item 12. Peripheral portion 44 includes edge guidance lines positioned at predetermined distances from the perimeter of crown planar base 22. The edge guidance lines comprise an inner boundary line positioned closer to the center of crown backer 14 and an outer boundary line positioned nearer to the perimeter of crown planar base 22. The inner boundary line defines a placement zone for decorative elements that require closer positioning to the central region, while the outer boundary line establishes a placement zone for decorative elements positioned near the edge of crown backer 14. This dual boundary configuration provides users with distinct placement options for different types of decorative elements such as ribbon loops or embellishments, enabling layered arrangements where inner decorative elements may comprise smaller or more delicate components and outer decorative elements may comprise larger or more prominent components around the circumference of crown backer 14.

Crown backer 14 includes a central aperture 46 positioned at the center for accommodating floral stems or other central decorative elements. Crown backer 14 also includes a plurality of crown apertures 48 formed through crown planar base 22 for securing decorative elements or for attaching crown backer 14 to other components such as a skirt backer 16. Crown apertures 48 serve as alignment points for securing decorative elements or connecting crown backer 14 to other backer components such as skirt backer 16. Crown apertures 48 are distributed throughout detachable central portion 40 and/or peripheral portion 44 and may be positioned to complement the guidance provided by visual indicia 28 while providing practical attachment points for assembly operations.

Crown apertures 48 may be configured as alignment apertures that facilitate the connection of crown backer 14 to skirt backer 16 through mechanical fasteners. In some cases, crown apertures 48 are positioned near the lower edge of crown backer 14 to enable coupling with corresponding apertures on skirt backer 16. Crown apertures 48 may have square, circular, or other geometric configurations that provide precise alignment interfaces for connecting multiple backer components during assembly.

Crown apertures 48 enable the insertion of mechanical fasteners such as zip ties, twist ties, or string that couple crown backer 14 to other components of decorative support assembly 10. The positioning of crown apertures 48 allows for secure attachment while maintaining the aesthetic integrity of the finished decorative arrangement. Crown apertures 48 may be sized to accommodate various types of fastening hardware while providing sufficient material strength around the aperture perimeters to resist tearing or deformation under mechanical stress.

Referring back to FIG. 1, decorative support assembly 10 includes a skirt backer 16. Skirt backer 16 provides structural support for the lower portion of wearable item 12 and serves as a foundation for attaching cascading decorative elements such as ribbons, streamers, and other ornamental components. Skirt backer 16 creates the elongated vertical section of wearable item 12 that extends below the crown portion, forming a layered arrangement that adds visual depth and movement to the overall decorative assembly.

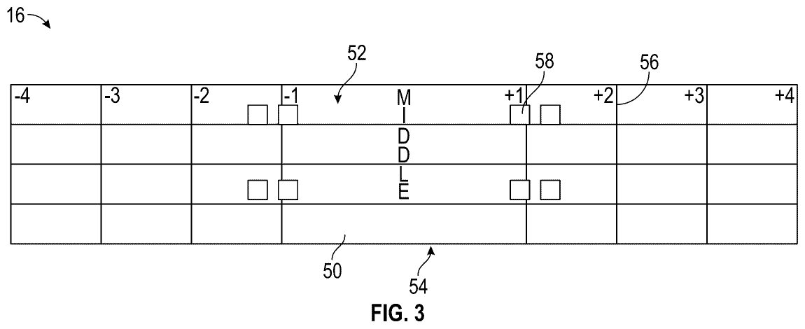

FIG. 3 shows a front view of skirt backer 16 in a rectangular configuration, in accordance with one embodiment of the present invention. Skirt backer 16 includes a skirt flat base 50 having a front face 52 and a rear face 54. Skirt flat base 50 provides a planar surface for mounting decorative components and serves as the structural foundation for the lower portion of the decorative arrangement. Front face 52 includes skirt visual indicia 56 that assist users in positioning decorative elements during assembly. Rear face 54 may be used for connecting skirt backer 16 to other components of decorative support assembly 10.

Skirt visual indicia 56 include lines defining dimensional markings distributed across front face 52. Skirt visual indicia 56 include horizontal and vertical reference lines that provide measurement indicators and alignment guides for positioning decorative elements. Skirt visual indicia 56 may include grid patterns, measurement scales, or other marking systems that facilitate systematic placement of cascading ribbons and decorative components. In some cases, skirt visual indicia 56 include numerical markings or spacing indicators that guide users in creating evenly distributed arrangements of decorative elements along the length of skirt backer 16.

Skirt flat base 50 includes a plurality of skirt apertures or skirt alignment apertures 58 formed through the material. Skirt apertures 58 are positioned at various locations on skirt flat base 50 and may be used for securing decorative elements or for connecting skirt backer 16 to crown backer 14 or other components. Skirt apertures 58 may be configured in various geometric shapes to accommodate different fastening methods and decorative element types. In some aspects, skirt apertures 58 are provided in circular, square, rectangular, oval or any other shapes. The shape selection for skirt apertures 58 may vary based on their intended function within skirt flat base 50. Alignment apertures positioned along the upper edge of skirt backer 16 for connecting to crown backer 14 may utilize square or circular configurations to ensure precise positioning during assembly.

Skirt apertures 58 facilitate the attachment of mechanical fasteners, ribbons, or other connecting elements during the assembly process. Skirt apertures 58 are positioned along the upper, middle or lower portion of skirt flat base 50. Skirt apertures 58 serve as alignment points for connecting skirt backer 16 to crown backer 14 through corresponding crown apertures 48. Skirt apertures 58 enable precise positioning of skirt backer 16 relative to crown backer 14 during assembly, ensuring proper structural connection and aesthetic integration between the crown and cascading portions of decorative support assembly 10. Skirt apertures 58 may be spaced at regular intervals along the upper edge of skirt flat base 50 to provide multiple connection options and enhanced structural stability.

Skirt apertures 58 distributed throughout the body of skirt flat base 50 facilitate attachment of cascading ribbons, streamers, and other second decorative articles 68 that form the elongated portion of wearable item 12. Skirt apertures 58 may correspond to the guidance provided by skirt visual indicia 56, enabling users to achieve systematic placement of decorative elements at predetermined locations along the length and width of skirt backer 16. Skirt apertures 58 enable mechanical fastening methods that provide secure attachment while allowing for adjustment or replacement of decorative elements during assembly or customization processes.

FIG. 4 demonstrates the operation of crown backer 14 during the assembly process where first decorative articles 66 are attached using the guidance provided by visual indicia 28. The assembly process begins with selecting an appropriate crown backer 14 based on the desired shape and size of the finished wearable item 12. A user 60 utilizes visual indicia 28 on crown backer 14, such as radial lines and concentric circular guides 30, to plan the placement of first decorative articles 66. The different line styles within visual indicia 28, including solid and dotted lines, provide distinct reference points for different types or layers of first decorative articles 66. Users select specific line types as starting points for their assembly sequence, ensuring consistent spacing and alignment throughout the construction process. The operation begins with positioning first decorative articles 66 around peripheral portion 44 of crown backer 14 according to the radial alignment references established by the alternating solid and dotted tick marks within visual indicia 28. The placement of first decorative articles 66 follows concentric circular guides 30, including first circular guide 32, second circular guide 34, and/or third circular guide 36, to maintain consistent radial distances from central aperture 46 while utilizing quadrant guides 38 to achieve balanced angular distribution around the circumference of crown planar base 22.

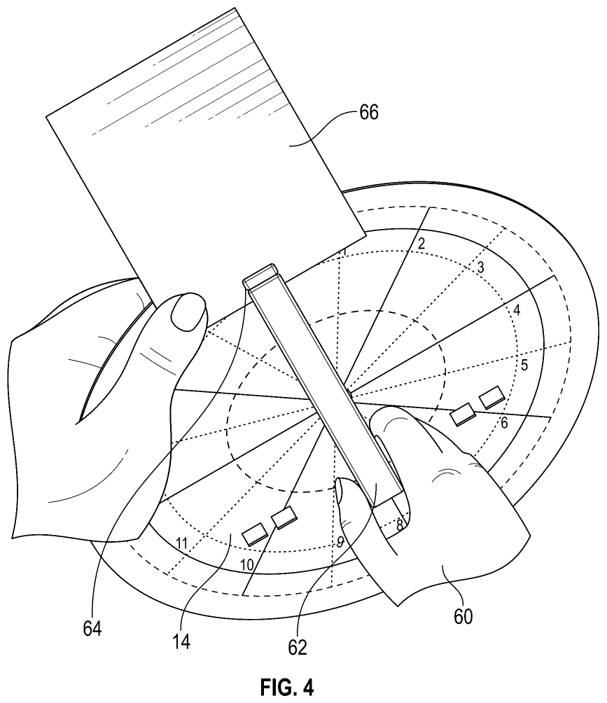

The operation of crown backer 14 incorporates the access functionality provided by detachable central portion 40 and weakened boundary 42. User 60 attaches ribbon loops as first decorative articles 66 to crown backer 14 using the alignment guides provided by visual indicia 28. In some implementations, user 60 folds ribbons into loops and secures them to crown backer 14 using fastening tool 62 such as staples or adhesive. The radial tick marks within visual indicia 28 assist in positioning the loops at regular intervals around the perimeter of crown backer 14. During assembly, weakened boundary 42 is opened or detachable central portion 40 is folded back to provide interior access for fastening tool 62. The inner slits or openings created by weakened boundary 42 allow users to insert a standard stapler easily, eliminating the need for specialized long-reach staplers. Users access different areas of peripheral portion 44 through these openings, enabling efficient attachment of first decorative articles 66 without awkward positioning or handling. This access capability enables the insertion of standard staplers through weakened boundary 42 to reach attachment points throughout peripheral portion 44 that would otherwise be inaccessible. The alternating solid and dotted line pattern within visual indicia 28 guides users in creating multi-layered arrangements where different ribbon types or colors are systematically positioned as first decorative articles 66. As shown in FIG. 5, the completed attachment of first decorative articles 66 demonstrates how the placement guidance provided by visual indicia 28 results in balanced and symmetrical decorative arrangements around crown planar base 22.

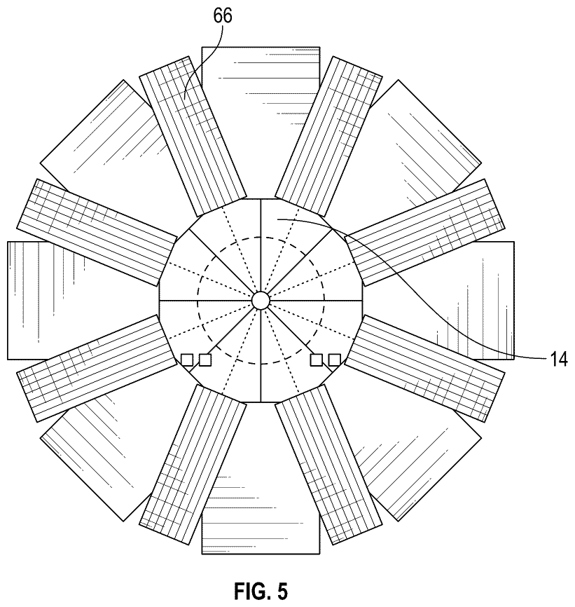

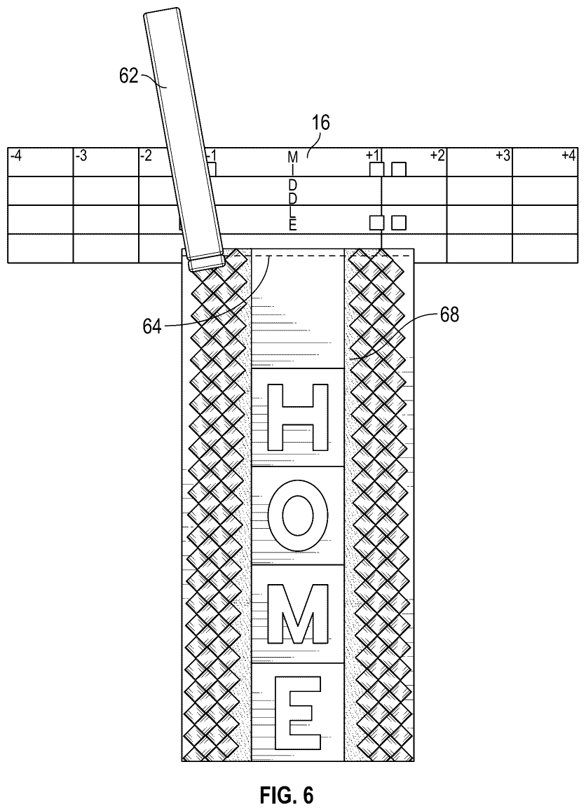

In some cases, user 60 attaches ribbon tails as additional first decorative articles 66 to crown backer 14. Concentric circular guides 30 on crown backer 14 help in positioning the tails at consistent distances from central aperture 46. User 60 varies the length of the tails to create a layered effect among first decorative articles 66. The assembly process includes attaching a central decorative element, such as a large flower or embellishment, to crown backer 14. In some implementations, user 60 removes detachable central portion 40 of crown backer 14 to create an opening for securing the central element through central aperture 46. FIG. 6 illustrates the operation of skirt backer 16 during the assembly process where second decorative articles 68 are positioned and secured to create the cascading portion of decorative support assembly 10. The operation utilizes skirt visual indicia 56 printed on front face 52 of skirt flat base 50 to guide the placement of ribbon elements, streamers, and other elongated decorative components across the surface. The dimensional markings and alignment guides within skirt visual indicia 56 enable user 60 to achieve consistent spacing and balanced distribution of second decorative articles 68 along the length and width of skirt flat base 50.

The operation of skirt backer 16 incorporates a fastening tool 62 for securing second decorative articles 68 through skirt apertures 58 positioned at strategic locations throughout skirt flat base 50. The fastening operation provides reliable mechanical attachment while maintaining the structural integrity of the cascading decorative elements during assembly and subsequent use. The operation enables layered arrangements where different types of second decorative articles 68 are positioned to create visual depth and textural variety within the cascading portion of wearable item 12.

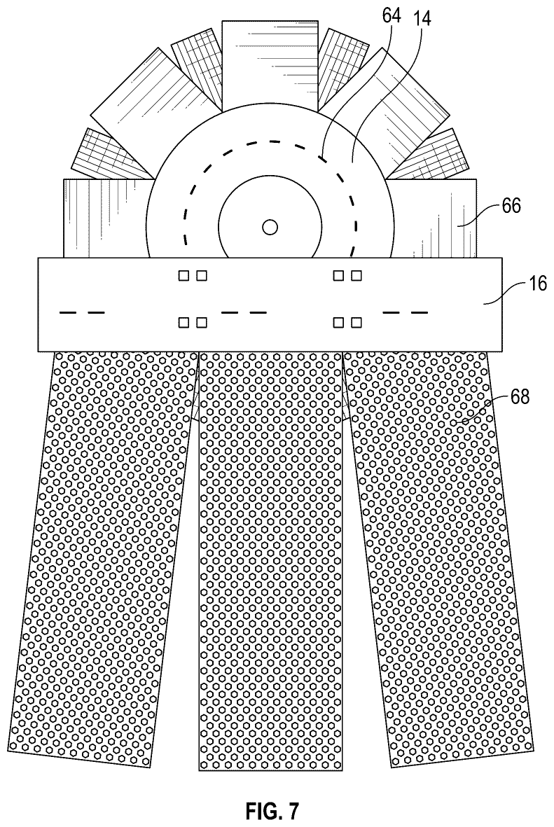

FIG. 7 demonstrates the connection operation where crown backer 14 and skirt backer 16 are aligned and coupled to form the complete decorative support assembly 10. Specifically, FIG. 7 shows a rear view of decorative support assembly 10 illustrating how crown backer 14 and skirt backer 16 are connected. The connection operation involves positioning crown backer 14 above skirt backer 16 while aligning corresponding crown apertures 48 formed through crown planar base 22 with skirt apertures 58 of skirt flat base 50. The alignment of these apertures facilitates mechanical connection through fasteners 64, which comprise zip ties, twist ties, staples, pins, or string that couple the crown and skirt components together. The alignment ensures proper structural integration between the radial decorative arrangement of first decorative articles 66 on crown backer 14 and the cascading decorative arrangement of second decorative articles 68 on skirt backer 16.

The connection of crown backer 14 above skirt backer 16 maintains the positioning and integrity of first decorative articles 66 attached to front face 24 of crown backer 14 while integrating with second decorative articles 68 attached to front face 52 of skirt backer 16. This enables independent preparation of the crown and skirt components followed by connection to create the unified decorative item 12. Crown apertures 48 and skirt apertures 58 enable proper alignment and fasteners 64 are used to secure crown backer 14 and skirt backer 16.

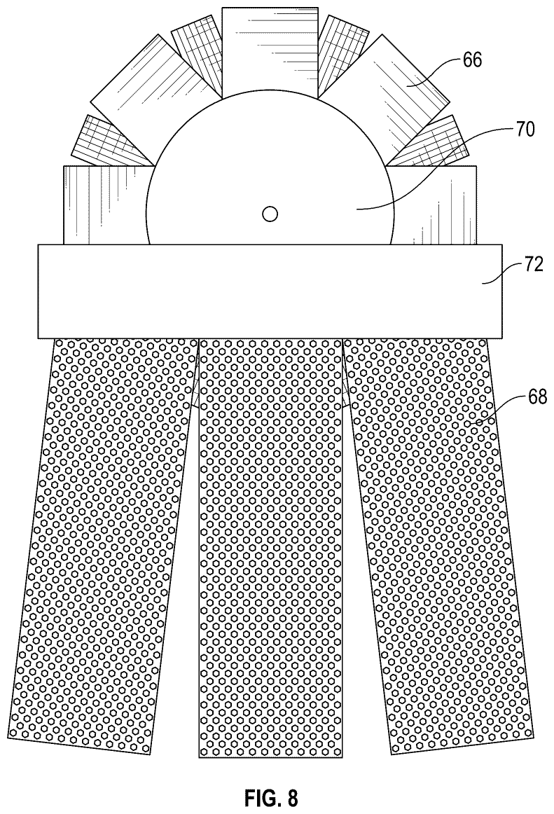

FIG. 8 illustrates the finishing operation where a crown cover 70 and a skirt cover 72 are applied to provide professional appearance and concealment of attachment hardware on rear face 26 of crown backer 14 and rear face 54 of skirt backer 16. The finishing operation involves positioning crown cover 70 beneath rear face 26 of crown planar base 22 to conceal protruding fasteners 64 and other attachment hardware used during assembly of first decorative articles 66. Similarly, skirt cover 72 is positioned beneath rear face 54 of skirt flat base 50 to conceal fastening hardware used during attachment of second decorative articles 68.

The finishing operation ensures that the completed decorative support assembly 10 presents a clean appearance from all viewing angles while maintaining the structural integrity and decorative characteristics established during the assembly process. The operation of crown cover 70 and skirt cover 72 provides smooth rear surfaces that eliminate visual and tactile irregularities created by exposed fastener ends on rear face 26 and rear face 54, enabling wearable item 12 to maintain aesthetic appeal during use. The finishing operation completes the systematic assembly process by addressing both functional and aesthetic requirements of the decorative arrangement, resulting in a unified decorative support assembly 10 that combines the radial arrangement of crown backer 14 with the cascading arrangement of skirt backer 16.

Crown backer 14 and skirt backer 16 are joined together using the alignment features described previously, such as corresponding crown apertures 48 and skirt apertures 58 along with mechanical fasteners 64. This connection creates a seamless transition between the upper crown portion and the lower cascading sections of decorative support assembly 10.

In some cases, additional decorative elements are incorporated throughout the assembled wearable item 12. These elements include smaller flowers, trinkets, or themed embellishments that complement the overall design aesthetic established by first decorative articles 66 and second decorative articles 68.

The fully assembled wearable item 12 is designed to be worn on clothing, such as pinned to a dress or shirt. The structural support provided by crown planar base 22 and skirt flat base 50 in both the crown and skirt portions helps maintain the shape and arrangement of the decorative elements when worn.

FIG. 1 illustrates how decorative support assembly 10 facilitates the creation of a balanced and visually appealing wearable item 12. The arrangement of decorative elements, guided by visual indicia 28 and skirt visual indicia 56 along with alignment features of crown backer 14 and skirt backer 16, results in a symmetrical and organized display when fully assembled. The functionally distinct components of crown backer 14 and skirt backer 16 work together to form an instructional craft system that enables repeatable and professional results.

Decorative support assembly 10 includes a double mum backer (not shown). The double mum backer functions similarly to skirt backer 16 as a functionally distinct component. This double mum backer is formed from cardstock material and has an oval-shaped outline. In some cases, the double mum backer measures approximately 4 inches in width and 8 inches in length, providing a larger surface area for creating more elaborate designs for wearable item 12.

The double mum backer includes two small circular apertures positioned along its length, similar to skirt apertures 58. These apertures are designed to accommodate floral stems or other decorative elements. In some implementations, the apertures are evenly spaced and centered within the oval form of the backer. The apertures are also configured as square-shaped apertures to provide precise alignment with corresponding square-shaped apertures on other backer components.

While the double mum backer is oriented vertically as shown in FIG. 6 for skirt backer 16, in some cases, it is used horizontally when incorporated into decorative arrangements. This flexibility in orientation allows for versatile use in creating various designs for wearable item 12 within the instructional craft system.

The oval shape of the double mum backer provides additional width compared to traditional circular crown backer 14. This increased width enables users to create larger or more elaborate cascading designs. In some cases, the wider backer allows for the attachment of additional ribbons, garlands, or other second decorative articles 68, resulting in a fuller and more dramatic appearance for the finished wearable item 12. Edge guidance lines positioned at predetermined distances from the perimeter provide inner and outer boundary options for placement of decorative elements.

The presence of two floral stem apertures on the double mum backer allows for the incorporation of multiple flowers or larger floral arrangements. In some implementations, users use these apertures to create a double flower design, with two blooms positioned side by side. Alternatively, the apertures are used to secure larger, more elaborate floral elements that require additional support. The apertures are configured as square-shaped apertures for enhanced alignment capabilities.

In some cases, the double mum backer is used in conjunction with other functionally distinct components, such as crown backer 14 or additional skirt elements. The oval shape provides a smooth transition between different sections of decorative support assembly 10, allowing for seamless integration of various decorative elements within the instructional craft system.

The simple, minimalist design of the double mum backer provides a versatile foundation for creating a wide range of styles for wearable item 12. The clean, defined edges of the cardstock material offer structural integrity while allowing for easy customization and decoration. Edge guidance lines are incorporated to assist in positioning decorative elements at consistent distances from the perimeter.

Decorative support assembly 10 includes a large oval backer (skirt backer 16). This large oval backer is formed from cardstock material and has an elongated oval shape with rounded ends, similar to the construction of skirt flat base 50. In some cases, the large oval backer measures approximately 5 inches in width and 11 inches in length, providing an even larger surface area compared to the double mum backer described previously. This functionally distinct component operates as part of the instructional craft system.

The large oval backer includes two circular apertures positioned vertically along its length, functioning similarly to crown apertures 48. These apertures are designed to accommodate floral stems or other decorative elements. In some implementations, the apertures are evenly spaced and centered within the elongated oval form of the backer. The apertures are configured as square-shaped apertures to provide precise alignment with corresponding square-shaped apertures on other backer components.

In some cases, a stencil used with the decorative support assembly may be manufactured using the same cutting or printing operations applied to the backers. For example, die-cutting, laser cutting, or digital printing may be used to form stencil openings corresponding to radial lines, concentric guides, alignment zones, or flower-placement apertures. Multiple stencil sizes or universal stencil formats may be produced to accommodate the various backer shapes described herein.

While the large oval backer is oriented vertically, in some cases, it is used horizontally when incorporated into decorative arrangements. This flexibility in orientation allows for versatile use in creating various designs for wearable item 12 within the instructional craft system framework.

The elongated oval shape of the large oval backer provides additional width and length compared to traditional circular crown backer 14 or smaller oval backers. This increased size enables users to create larger or more elaborate crown designs. In some cases, the wider and longer backer allows for the attachment of additional ribbons, garlands, or other first decorative articles 66, resulting in a fuller and more dramatic appearance for the finished wearable item 12. Edge guidance lines positioned at predetermined distances from the perimeter provide inner and outer boundary options for placement of decorative elements such as ruffles or ribbon loops.

In some cases, decorative support assembly 10 incorporates variations and alternative embodiments to enhance functionality or expand design options. These modifications include changes to shapes, sizes, materials, and additional features of the functionally distinct components. The systematic approach established by the guidance features is adapted to accommodate various design requirements while maintaining the assembly advantages of the overall instructional craft system.

Crown backer 14 includes detachable central portion 40 defined by weakened boundary 42. In some implementations, weakened boundary 42 comprises a perforated line, allowing for easy removal of detachable central portion 40 and creating inner slits that provide access for fastening tools. Alternative embodiments utilize different mechanisms for creating weakened boundary 42, such as scored lines, partial cuts, or thinned material sections that facilitate selective detachment while maintaining structural integrity during assembly operations. These inner slits enable insertion of standard staplers without requiring specialized long-reach staplers.

Detachable central portion 40 is removable to create an opening for attaching a central decorative element through central aperture 46. The inner slits created by the weakened boundary provide access points for fastening tools during assembly. In some cases, the shape of detachable central portion 40 is varied to accommodate different types of central decorations. For example, detachable central portion 40 is circular, star-shaped, or custom-designed to match specific floral or embellishment shapes that serve as focal points for the decorative arrangement.

In some implementations, a stencil used with the backer may include one or more access openings that correspond to the weakened boundary or detachable-center region of the backer. These openings allow the stencil to remain in place during assembly while still permitting insertion of fastening tools such as staplers. This facilitates stable alignment of decorative elements by enabling the user to fasten components without removing the stencil mid-assembly.

Decorative support assembly 10 includes crown planar base 22 with detachable central portion 40 and peripheral portion 44 as functionally distinct components. In some implementations, peripheral portion 44 includes a plurality of crown apertures 48 formed through the material. Crown apertures 48 vary in size, shape, and arrangement to accommodate different attachment methods or decorative element types, providing flexibility in securing various components during assembly operations. Some crown apertures 48 are configured as square-shaped apertures for precise alignment with corresponding square-shaped apertures on other components.

Detachable central portion 40 of crown planar base 22 is defined by weakened boundary 42 and selectively detachable from peripheral portion 44. Alternative embodiments explore different configurations of weakened boundary 42, such as multiple detachable sections or partially detachable flaps that remain connected to peripheral portion 44 while providing inner slits for fastening tool 62 access during assembly operations. These inner slits allow insertion of standard staplers to reach attachment points throughout the peripheral portion.

In some cases, peripheral portion 44 includes visual indicia 28 for positioning decorative components in a radial arrangement around crown backer 14 as part of the instructional craft system. Visual indicia 28 take various forms, such as printed markings, embossed patterns, or cut-out shapes that provide systematic guidance for decorative element placement. Alternative embodiments explore different arrangements of visual indicia 28, such as asymmetrical patterns or themed designs that complement specific decorative styles while maintaining the functional advantages of the instructional craft system.

Any of the visual indicia described herein—including radial tick marks, concentric circular guides, quadrant labels, alignment zones, or edge-placement boundaries—may alternatively be provided via a stencil rather than printed or etched directly onto the backer. The stencil may be formed from cardstock, plastic, or other sheet materials and may include printed indicia or cut-through apertures that replicate the guidance patterns. The stencil may be reusable and offered as a standalone component of the instructional craft system.

Visual indicia 28 include concentric circular guides 30 for positioning decorative components at varying radial distances from central aperture 46. In some implementations, concentric circular guides 30 are supplemented with additional markings or features to facilitate more complex decorative arrangements within the instructional craft system. For example, concentric circular guides 30 incorporate color-coding or numerical indicators to suggest specific placement patterns for first decorative articles 66 or other embellishments positioned around crown backer 14. The concentric circular guides 30 comprise different line styles including stitched lines, solid lines, and dotted lines to distinguish between different placement zones.

Alternative embodiments explore the use of different materials for the functionally distinct components of crown backer 14 and skirt backer 16. While cardboard or cardstock are commonly used, variations include lightweight plastics, biodegradable materials, or fabric-based backers for increased flexibility. These material choices influence the durability, weight, and overall aesthetic characteristics of the finished wearable item 12 while maintaining the structural support requirements for decorative arrangements within the instructional craft system.

In some cases, decorative support assembly 10 incorporates additional features to enhance customization options within the instructional craft system. For example, crown backer 14 and skirt backer 16 include pre-cut slots or channels for integrating LED lights or other electronic components. Alternative embodiments explore modular backer designs that allow users to combine multiple smaller functionally distinct components to create larger or more complex decorative structures while maintaining the systematic assembly approach. Edge guidance lines are incorporated to provide reference points for positioning these additional features.

The shapes of crown backer 14 are further diversified to accommodate a wider range of design preferences within the instructional craft system. In addition to traditional circular and heart configurations, alternative embodiments include more intricate outlines such as flowers, animals, or school mascots. These specialized shapes are designed with strategic crown apertures 48 placements, including square-shaped apertures where appropriate, to maintain the characteristic form when decorated with first decorative articles 66 and other ornamental components. Edge guidance lines positioned at predetermined distances from the perimeter assist in maintaining proper spacing for decorative elements.

Some variations of decorative support assembly 10 incorporate adjustable or expandable features within the functionally distinct components. For example, crown backer 14 includes telescoping sections that allow users to customize the size of the finished wearable item 12. Similarly, skirt backer 16 features extendable panels to create longer or fuller cascading effects with second decorative articles 68 while maintaining the structural integrity of the overall arrangement. Inner slits are positioned strategically to accommodate these adjustable features while maintaining access for fastening tools.

Alternative embodiments explore the integration of digital technologies with decorative support assembly 10 and its instructional craft system. For instance, crown backer 14 and skirt backer 16 include QR codes or NFC tags that link to online tutorials, design inspiration, or augmented reality previews of potential decorative arrangements. These digital enhancements provide users with additional guidance and creative resources while maintaining the practical assembly advantages of the physical backer system and its functionally distinct components.

In some cases, decorative support assembly 10 is adapted for use in creating coordinated sets of wearable items 12 and garters. This involves developing scaled-down versions of the functionally distinct components crown backer 14 and skirt backer 16 or creating specialized connectors that allow multiple smaller decorative arrangements to be linked together into larger coordinated displays while maintaining the systematic assembly approach established by the instructional craft system guidance features. Square-shaped apertures are particularly useful for these connector applications.

These variations and alternative embodiments demonstrate the potential for expanding the functionality and design options of decorative support assembly 10 and its instructional craft system. By exploring different materials, shapes, features, and technologies, the system of functionally distinct components is adapted to meet a wide range of user preferences and creative needs in the realm of decorative wearable items 12 while maintaining the systematic assembly advantages and professional results facilitated by the guidance features, including inner slits, edge guidance lines, stitched lines, and square-shaped apertures incorporated into the backer components.

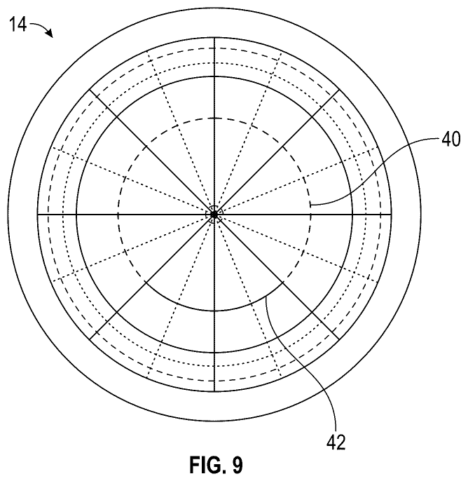

FIG. 9 shows a crown backer 14 having detachable central portion 40 with weakened boundary 42 positioned along the bottom edge of detachable central portion 40 while maintaining a solid connection at the top portion, in accordance with another embodiment of the present invention. This configuration enables detachable central portion 40 to be folded downward or opened to provide access for fastening tool 62 while retaining structural connection to crown backer 14 through the upper attachment point. The partial attachment arrangement allows for convenient access to interior regions of crown backer 14 during assembly operations while maintaining the integrity of the overall structure.

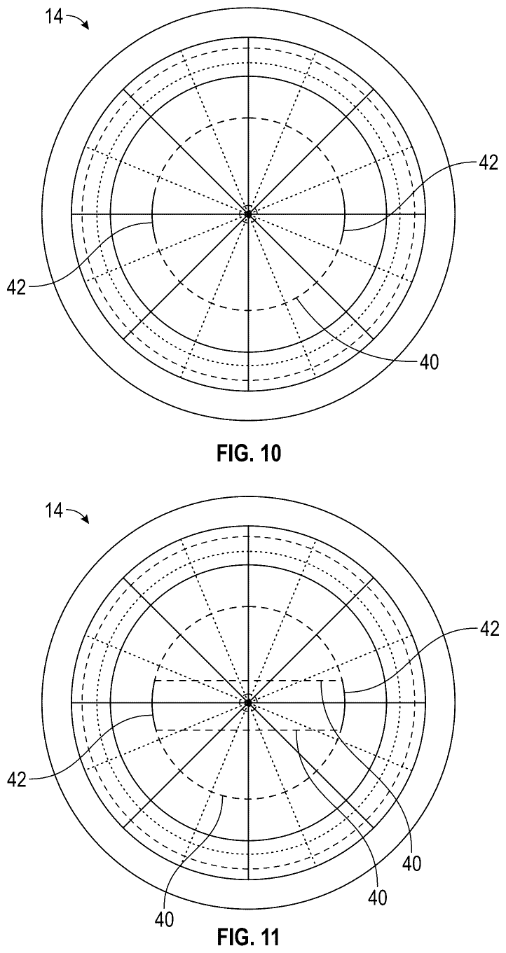

FIG. 10 shows a crown backer 14 having detachable central portion 40 with weakened boundary 42 provided on both the left and right sides of detachable central portion 40, with solid connection segments at the top and bottom positions, in accordance with another embodiment of the present invention. This configuration allows detachable central portion 40 to remain partially attached to crown backer 14 at the top and bottom connection points while enabling access through the sides for inserting fastening tool 62 during assembly. The bilateral opening arrangement provides enhanced accessibility for positioning fastening tool 62 at various angles while maintaining structural stability through the dual connection points.

FIG. 11 shows crown backer 14 having a rectangular detachable central portion 40 positioned at the center of the circular crown backer 14, in accordance with another embodiment of the present invention. Detachable central portion 40 is defined by weakened boundary 42 forming a rectangular outline. Weakened boundary 42 extends along both vertical sides of rectangular detachable central portion 40, allowing the central portion to be selectively removed or folded back while maintaining connection points at the top and bottom edges. The rectangular configuration of detachable central portion 40 provides a larger access opening compared to circular configurations, facilitating the insertion of fastening tool 62 and enabling improved maneuverability during attachment of first decorative articles 66 to peripheral portion 44.

These alternative embodiments of weakened boundary 42 demonstrate the versatility of the access feature design, enabling users to select a configuration that best suits their assembly preferences and fastening tool requirements. The various weakened boundary 42 configurations maintain the functionality of providing interior access while preserving the structural integrity of crown backer 14 through strategic retention of connection points.

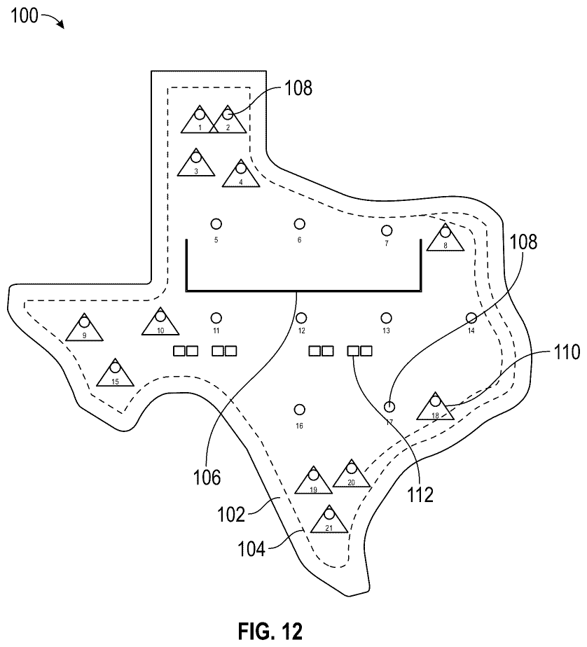

FIG. 12 shows a crown backer 100 formed in the shape of the state of Texas, in accordance with another embodiment of the present invention. Crown backer 100 provides a specialized configuration for creating Texas-themed decorative arrangements that maintain the recognizable geographic outline of the state when assembled with decorative elements. Crown backer 100 includes a base 102 having an outline that follows the geographic contours of Texas, providing users with a distinctive foundation for creating regionally-themed wearable items 12.

Base 102 of crown backer 100 includes a boundary 104 formed at a predetermined distance inward from the edges of base 102. Boundary 104 provides a reference perimeter that assists users in positioning decorative elements while maintaining appropriate spacing from the outer edges of the Texas-shaped outline. The positioning of boundary 104 ensures that decorative components do not extend beyond the intended shape boundaries, preserving the recognizable Texas silhouette in the finished arrangement. As can be seen, boundary 104 is positioned at a predetermined distance inward from the outer edges of base 102, creating a reference perimeter that defines the working area for decorative element placement. Boundary 104 follows the contours of the Texas-shaped outline while maintaining consistent spacing from the outer perimeter of base 102. In some cases, boundary 104 is positioned approximately half an inch inward from the edges of the base 102, though this distance may be adjusted based on the overall size of the crown backer 100 and the intended decorative elements. Boundary 104 serves as a visual guide that assists users in maintaining appropriate margins around the perimeter of the Texas shape, ensuring that decorative components remain within the intended geographic outline while preserving the recognizable state silhouette.

In some variations, a stencil may be used in conjunction with irregularly shaped backers such as Texas-shaped, heart-shaped, butterfly-shaped, or other themed outlines. The stencil may include cutouts or markings corresponding to recommended decorative-element placement zones or flower-placement apertures. Because the stencil is not limited to a particular outline, a single stencil may be dimensioned to align with standard spacing intervals applicable across multiple irregular shapes, enabling users to maintain consistent spacing and symmetrical visual layouts even when the underlying backer silhouette is non-circular.

Base 102 includes a weakened boundary 106 positioned within the interior region of the Texas-shaped outline. In the illustrated embodiment, weakened boundary 106 is provided in a U-shaped configuration, though alternative shapes and locations may be utilized depending on design requirements and assembly preferences. The U-shaped configuration of weakened boundary 106 provides a large access opening that accommodates various fastening tool orientations and enables efficient attachment of decorative elements throughout the peripheral regions of base 102. Weakened boundary 106 functions similarly to the weakened boundaries described in previous embodiments, providing access for fastening tool 62 during assembly operations while maintaining structural integrity of crown backer 100. Weakened boundary 106 enables users to create an opening within base 102 that allows for insertion of the fastening tool during attachment of decorative elements to peripheral areas of crown backer 100. The positioning of weakened boundary 106 within the interior region of the Texas shape ensures that the access opening does not interfere with the recognizable outline of the state while providing sufficient clearance for maneuvering the fastening tool during assembly operations. Weakened boundary 106 may be selectively opened or removed to create temporary access, or may be designed to remain partially attached to base 102 through connection points that maintain structural integrity while enabling functional access.

Crown backer 100 includes a plurality of first apertures 108 distributed across the surface of base 102. First apertures 108 are strategically positioned throughout the Texas-shaped outline to accommodate decorative elements such as floral stems while maintaining the characteristic shape when the arrangement is completed. The placement pattern of first apertures 108 enables systematic positioning of flowers and other decorative components in locations that preserve the recognizable Texas silhouette when viewed from the front.

In some implementations, shapes 110 are drawn around certain first apertures 108 to provide additional guidance for decorative element placement. As shown in FIG. 12, triangular shapes 110 are illustrated around selected or all of first apertures 108, which may indicate specific sizing requirements or placement guidance for particular types of decorative elements. The triangular shapes 110 may correspond to recommended flower sizes or may indicate apertures designated for specific decorative components. First apertures 108 may also be provided without shapes 110 in alternative configurations, depending on the level of guidance desired for the assembly process. The triangular shapes 110 are provided for illustrative purposes, and any shape may be substituted without departing from the scope of the present invention. Shapes 110 may include written designations or dimensional information printed adjacent to the triangular markings to provide explicit size guidance for users during assembly. In some implementations, shapes 110 are accompanied by text indicating “3 inch” or “4 inch” to specify the recommended flower diameter for each marked aperture. The combination of visual shapes 110 and textual information creates a comprehensive guidance system that accommodates users with different learning preferences and assembly experience levels.

First apertures 108 may also be provided without shapes 110 in alternative configurations, depending on the level of guidance desired for the assembly process. Shapes 110 may include written designations or dimensional information printed adjacent to the triangular markings to provide explicit size guidance for users during assembly. In some implementations, shapes 110 are accompanied by text indicating “3 inch” or “4 inch” to specify the recommended flower diameter for each marked aperture. The combination of visual shapes 110 and textual information creates a comprehensive guidance system that accommodates users with different learning preferences and assembly experience levels.

Base 102 includes a plurality of crown alignment apertures 112 positioned along a central vertical axis of crown backer 100. Crown alignment apertures 112 are configured to align with corresponding apertures on a skirt backer, facilitating the modular connection between crown backer 100 and the skirt portion of decorative support assembly 10. The strategic positioning of crown alignment apertures 112 along the centerline enables proper alignment and secure attachment when coupling crown backer 100 to skirt backer components during assembly operations.

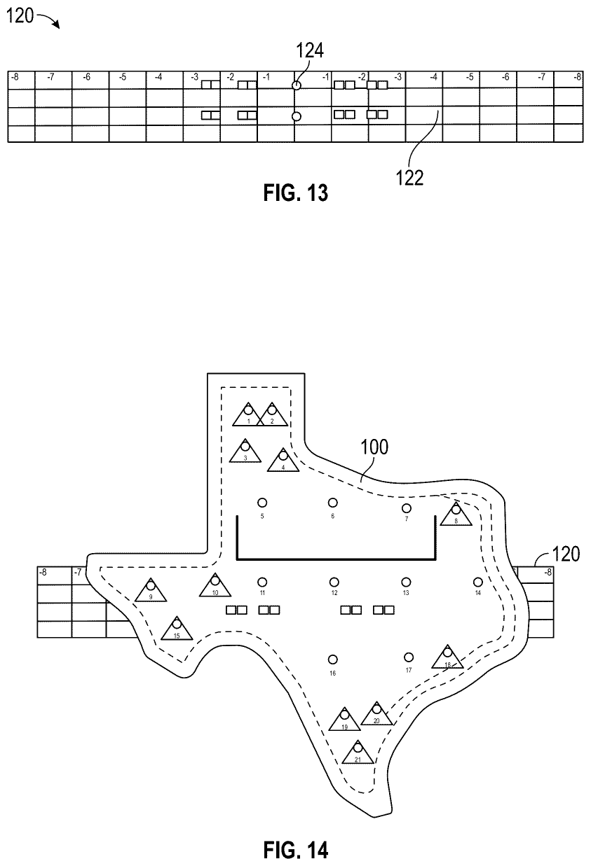

FIG. 13 shows a skirt backer 120 configured for use with crown backer 100, in accordance with one embodiment of the present invention. Skirt backer 120 includes skirt indicia 122 comprising lines defining dimensional markings distributed across the surface. Skirt indicia 122 provide visual guidance for positioning decorative elements during assembly operations, similar to the skirt visual indicia 56 described in previous embodiments. The dimensional markings within skirt indicia 122 enable users to achieve consistent spacing and alignment of cascading decorative elements along the length of skirt backer 120.

Skirt backer 120 includes a plurality of skirt alignment apertures 124 formed through the material and positioned along the upper portion of the backer. Skirt alignment apertures 124 are configured to align with crown alignment apertures 112 of crown backer 100 when the components are positioned for connection during assembly. The alignment of skirt alignment apertures 124 with crown alignment apertures 112 enables mechanical coupling through fasteners 64, creating a secure connection between the Texas-shaped crown portion and the cascading skirt portion of the decorative arrangement.

The modular design of crown backer 100 and skirt backer 120 enables users to create Texas-themed decorative arrangements while maintaining the systematic assembly approach established by decorative support assembly 10. The specialized Texas-shaped configuration of crown backer 100 provides users with a distinctive design option that celebrates regional identity while incorporating the guidance features and assembly advantages of the broader decorative support system.

FIG. 14 demonstrates the placement of crown backer 100 over skirt backer 120 after aligning the components using their respective alignment apertures. The assembly process involves positioning crown backer 100 above skirt backer 120 while aligning crown alignment apertures 112 with skirt alignment apertures 124 to ensure proper connection between the Texas-shaped crown portion and the rectangular skirt portion. The alignment of these corresponding apertures facilitates mechanical coupling through fasteners 64, creating a secure structural connection that maintains the integrity of both the specialized Texas-shaped design and the cascading decorative arrangement.

The operation of crown backer 100 positioned over skirt backer 120 functions similarly to the connection process described for crown backer 14 and skirt backer 16 in previous embodiments. Crown backer 100 maintains the positioning and attachment of first decorative articles positioned around the Texas-shaped perimeter, while skirt backer 120 supports second decorative articles arranged in cascading patterns along its length.

The connection operation preserves the specialized characteristics of the Texas-themed design while incorporating the systematic assembly advantages established by the broader decorative support system. The alignment apertures enable precise positioning that ensures the Texas-shaped crown portion integrates seamlessly with the cascading skirt portion, maintaining both the recognizable geographic outline and the balanced distribution of decorative elements throughout the completed wearable item 12.

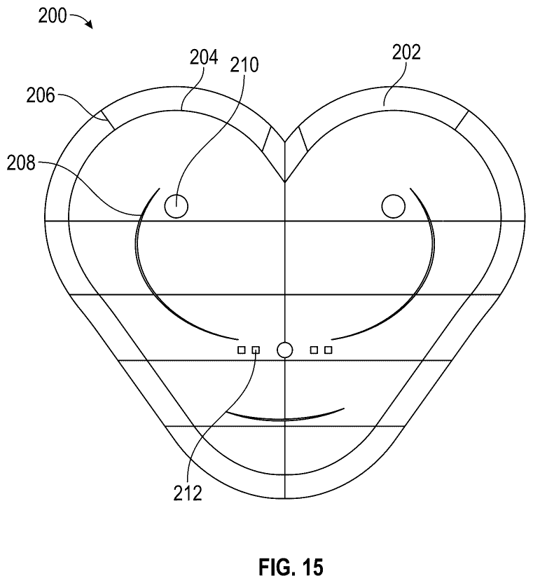

FIG. 15 shows a heart-shaped crown backer 200 that provides an alternative decorative configuration for creating romantic or themed wearable items 12. Heart-shaped crown backer 200 includes a base 202 having an outline that follows the characteristic heart shape, providing users with a distinctive foundation for creating love-themed or Valentine's Day decorative arrangements. The heart-shaped configuration of crown backer 200 offers users an additional design option that complements the circular and Texas-shaped variants while maintaining the systematic assembly approach established by decorative support assembly 10.

Base 202 of heart-shaped crown backer 200 includes a boundary 204 that defines the outer perimeter of the heart shape. Boundary 204 provides a reference line that assists users in positioning decorative elements while maintaining appropriate spacing from the outer edges of the heart-shaped outline. The positioning of boundary 204 ensures that decorative components do not extend beyond the intended shape boundaries, preserving the recognizable heart silhouette in the finished arrangement.

Base 202 is divided into zones 206 positioned along boundary 204 to provide systematic guidance for decorative element placement. Zones 206 enable users to achieve balanced and symmetrical arrangements around the heart-shaped perimeter by providing clearly defined reference areas for positioning various decorative components. The zones 206 facilitate consistent spacing and proportional distribution of decorative elements while maintaining the aesthetic integrity of the heart shape. Heart-shaped crown backer 200 may also include strategically positioned weakened boundary 208 such as openings or slits that allow for easier stapler (fastening tool 62) access when attaching ribbon loops or other decorative elements. These openings may be positioned on both sides and at the bottom of the heart shape to provide multiple access points for assembly. Weakened boundary 208 functions similarly to the weakened boundaries described in previous embodiments, providing access for fastening tool 62 during assembly operations while maintaining structural integrity of heart-shaped crown backer 200. The positioning of weakened boundary 208 within the interior region ensures that the access opening does not interfere with the recognizable heart outline while providing sufficient clearance for maneuvering fastening tools during assembly operations.

Base 202 includes a plurality of first apertures 210 distributed across the surface of the heart-shaped outline. First apertures 210 are strategically positioned throughout the heart shape to accommodate decorative elements such as floral stems while maintaining the characteristic heart configuration when the arrangement is completed. The placement pattern of first apertures 210 enables systematic positioning of flowers and other decorative components in locations that preserve the recognizable heart silhouette when viewed from the front. First apertures 210 may be arranged in a specific pattern, with larger apertures positioned near the top curves of the heart and smaller apertures arranged in the central and lower portions. This configuration allows for the placement of different sized flowers while maintaining the distinctive heart shape. In some implementations, first apertures 210 are configured to work with flowers that are 3 inches and 6.5 inches in diameter.

Heart-shaped crown backer 200 includes a plurality of crown alignment apertures 212 positioned along a central vertical axis of the heart shape. Crown alignment apertures 212 are configured to align with corresponding apertures on a skirt backer, facilitating the modular connection between heart-shaped crown backer 200 and the skirt portion of decorative support assembly 10. The strategic positioning of crown alignment apertures 212 along the centerline enables proper alignment and secure attachment when coupling heart-shaped crown backer 200 to skirt backer components during assembly operations.

FIG. 16 demonstrates the assembly process for heart-shaped crown backer 200 during attachment of decorative elements. Heart-shaped crown backer 200 is used to connect first decorative articles 214 around the perimeter of the heart shape. First decorative articles 214 comprise ribbon loops that are systematically positioned at intervals along boundary 204 of heart-shaped crown backer 200. The assembly process utilizes the guidance provided by zones 206 to achieve consistent spacing and balanced distribution of first decorative articles 214 around the heart-shaped outline.

The operation of heart-shaped crown backer 200 incorporates the access functionality provided by weakened boundary 208, enabling users to insert fastening tools for securing first decorative articles 214 to base 202. The systematic placement of first decorative articles 214 follows the guidance provided by zones 206, ensuring that the decorative elements maintain the recognizable heart shape while creating a layered and textured appearance around the perimeter of heart-shaped crown backer 200.

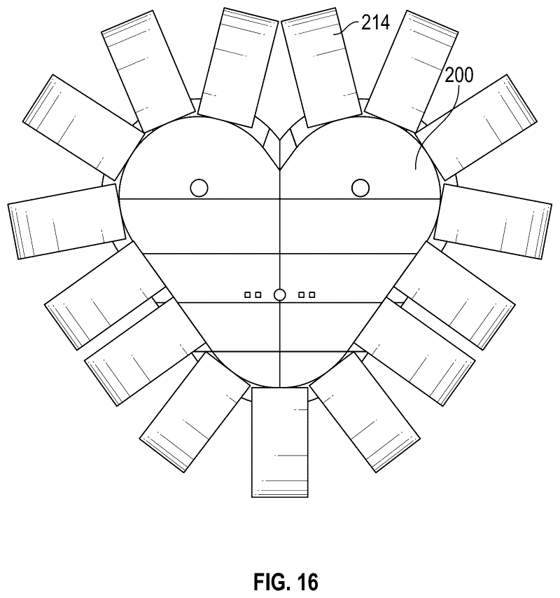

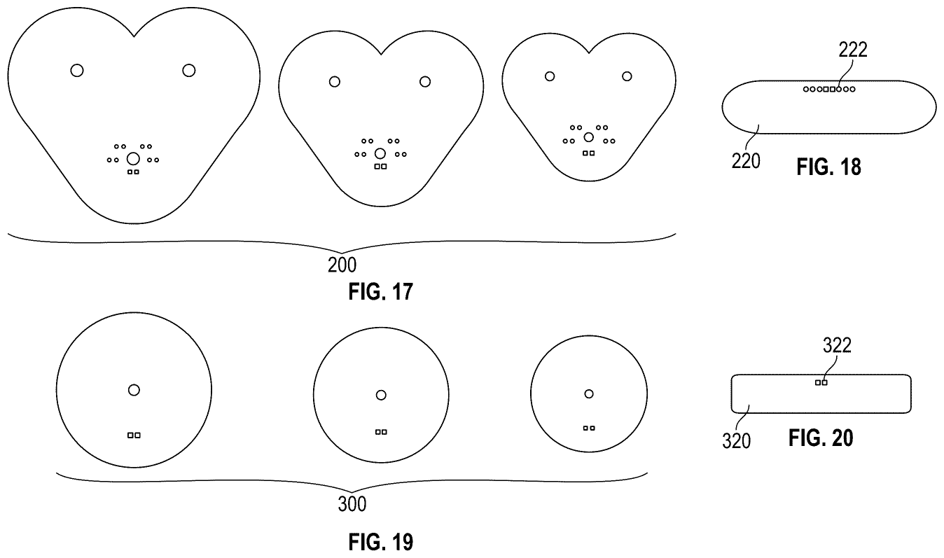

FIG. 17 shows heart-shaped crown backer 200 in multiple size configurations, demonstrating the scalability of the heart-shaped design for different decorative requirements. Heart-shaped crown backer 200 may be manufactured in various sizes to accommodate different user preferences and design specifications while maintaining the characteristic heart outline and guidance features described above.

FIG. 18 shows a skirt backer 220 configured for use with heart-shaped crown backer 200, in accordance with one embodiment of the present invention. Skirt backer 220 is provided in a horizontal oval configuration that complements the heart-shaped crown backer 200. The oval configuration of skirt backer 220 provides an elongated horizontal profile that may enhance the visual balance when coupled with the heart-shaped crown portion.

Skirt backer 220 includes skirt alignment apertures 222 positioned along the upper portion of the backer. Skirt alignment apertures 222 are configured to align with crown alignment apertures 212 of heart-shaped crown backer 200 when the components are positioned for connection during assembly. The alignment of skirt alignment apertures 222 with crown alignment apertures 212 enables mechanical coupling through fasteners, creating a secure connection between the heart-shaped crown portion and the cascading skirt portion of the decorative arrangement.

The design of heart-shaped crown backer 200 and skirt backer 220 enables users to create heart-themed decorative arrangements while maintaining the systematic assembly approach established by decorative support assembly 10. Heart-shaped crown backer 200 utilizes skirt backer 220 to connect the decorative articles as explained above, with the heart-shaped crown portion supporting first decorative articles 214 arranged around the perimeter while skirt backer 220 provides structural foundation for second decorative articles positioned in cascading patterns along its length. The specialized heart-shaped configuration of crown backer 200 provides users with a distinctive design option that celebrates romantic themes while incorporating the guidance features and assembly advantages of the broader decorative support system.

FIG. 19 shows a crown backer 300 provided in a circular shape in multiple size configurations, demonstrating the scalability of the circular design for different decorative requirements. Crown backer 300 may be manufactured in various sizes to accommodate different user preferences and design specifications while maintaining the characteristic circular outline and guidance features described above.

FIG. 20 shows a skirt backer 320 configured for use with crown backer 300, in accordance with one embodiment of the present invention. Skirt backer 320 is provided in a rectangular configuration with rounded corners that complements the circular crown backer 300. The rectangular configuration of skirt backer 320 provides an elongated vertical profile that may enhance the visual balance when coupled with the circular crown portion.

Skirt backer 320 includes skirt alignment apertures 322 positioned along the upper portion of the backer. Skirt alignment apertures 322 are configured to align with corresponding apertures of crown backer 300 when the components are positioned for connection during assembly. The alignment of skirt alignment apertures 322 with the crown apertures enables mechanical coupling through fasteners, creating a secure connection between the circular crown portion and the cascading skirt portion of the decorative arrangement.

The design of crown backer 300 and skirt backer 320 enables users to create traditional circular decorative arrangements while maintaining the systematic assembly approach established by decorative support assembly 10. Crown backer 300 utilizes skirt backer 320 to connect the decorative articles as explained above, with the circular crown portion supporting first decorative articles arranged around the perimeter while skirt backer 320 provides structural foundation for second decorative articles positioned in cascading patterns along its length. The circular configuration of crown backer 300 provides users with a classic design option that accommodates traditional homecoming mum arrangements while incorporating the guidance features and assembly advantages of the broader decorative support system.

In some cases, crown backer 200 may be provided in a butterfly-shaped support backer configuration. The butterfly-shaped support backer includes a base having an outline that follows the characteristic butterfly shape, providing users with a distinctive foundation for creating nature-themed decorative arrangements. The butterfly-shaped configuration offers users an additional design option that complements the circular, Texas-shaped, and heart-shaped variants while maintaining the systematic assembly approach established by decorative support assembly 10.

The butterfly-shaped support backer includes a plurality of small circular apertures arranged in a specific pattern within the butterfly outline. The apertures are strategically positioned across the butterfly shape to accommodate flower stems while maintaining the characteristic butterfly silhouette when the arrangement is completed. The apertures may be distributed symmetrically across both wings of the butterfly design to ensure balanced visual weight and proportional distribution of decorative elements. In some implementations, the apertures are configured to work with flowers that are 4.5 inches in diameter, providing optimal sizing for maintaining the recognizable butterfly outline while accommodating standard floral components.

Crown backers may be manufactured in a variety of different shapes beyond those illustrated, including paw-shaped, horse-shaped, bow-shaped, and quadrilateral configurations. Each of these alternative shapes provides users with specialized design options for creating themed decorative arrangements that correspond to specific interests, events, or organizational affiliations. The different shapes may exist at different sizes to accommodate varying decorative requirements and user preferences while maintaining the characteristic outline and guidance features of each respective configuration.

For these shape variations, markings along the edge of the shape assist users in determining optimal positions for attaching outer decorative elements such as ribbon loops. The edge markings provide visual reference points that enable consistent spacing and balanced distribution of decorative components around the perimeter of irregularly shaped backers. In some implementations, irregularly shaped backers include edge guidance lines positioned at predetermined distances from the perimeter, such as approximately half an inch from the edge. These edge guidance lines may provide inner and outer boundary options, allowing users to choose between different placement positions for decorative elements such as ruffles or ribbon loops based on their desired aesthetic effect and coverage requirements.

The plurality of apertures in each shape are sized to accommodate floral stem insertion while indicating to users the optimal positions for flower placement to maintain the intended shape configuration. The apertures serve as positioning templates that guide systematic placement of decorative elements in locations that preserve the recognizable outline of the respective shape when the final arrangement is assembled. The specific placement of apertures enables balanced coverage across the entire surface area of the support backer while maintaining the distinctive characteristics of each shape configuration.

In each of these irregularly shaped support backers, the arrangement of apertures provides a template for positioning decorative elements in a manner that maintains the recognizable outline of the respective shape when the final decorative item is completed. The aperture placement patterns are designed to ensure that floral elements and other decorative components contribute to the overall shape definition rather than obscuring or distorting the intended silhouette. The systematic positioning enabled by the aperture arrangements facilitates consistent results across multiple assembly operations while accommodating user creativity and customization preferences.

The size and spacing of the apertures in these irregularly shaped support backers may be designed to work with flowers of various diameters to provide flexibility in decorative element selection. In some cases, the apertures are sized and spaced to accommodate flowers with diameters ranging from approximately 3 inches to 6.5 inches, enabling users to create layered arrangements with different floral sizes while maintaining the structural integrity and visual coherence of the intended shape. The variable sizing capabilities allow for creative combinations of decorative elements while ensuring that the fundamental shape characteristics remain clearly defined in the finished arrangement.

The irregularly shaped support backers provide users with options for creating themed or personalized decorative wearable items that correspond to specific occasions, interests, or organizational affiliations. The Texas-shaped backer may be suitable for state-themed events, regional celebrations, or school spirit applications, while the heart and butterfly shapes may be appropriate for romantic occasions, nature-inspired designs, or seasonal celebrations respectively. The paw-shaped configuration may accommodate mascot-themed arrangements or animal-related celebrations, while horse-shaped backers may be suitable for equestrian events or western-themed occasions. Bow-shaped and quadrilateral configurations provide additional geometric options that may complement various decorative themes and user preferences while maintaining the systematic assembly advantages established by decorative support assembly 10.

In some implementations, the assembly process includes customizing wearable item 12 with personalized elements such as monograms, names, or school-related decorations. These elements are positioned using visual indicia 28 and skirt visual indicia 56 on the respective backers to ensure proper placement within the overall design. The alignment guides provided by concentric circular guides 30 and quadrant guides 38 facilitate systematic positioning of personalized decorative components while maintaining the balanced distribution established by the guidance system.

The completed wearable item 12 is prepared for wearing by attaching a pin or other fastening mechanism to rear face 26 of crown backer 14. In some cases, user 60 adds additional support or reinforcement to ensure wearable item 12 remains securely attached when worn. Crown cover 70 accommodates the attachment hardware while maintaining the finished appearance of the rear surface.

Decorative support assembly 10 allows for modifications and adjustments throughout the assembly process. Users rearrange or replace first decorative articles 66 and second decorative articles 68 as needed, utilizing removable fasteners 64 and the alignment features provided by visual indicia 28 to maintain the structural integrity of wearable item 12. The systematic guidance provided by the backer components enables consistent repositioning of decorative elements during customization operations.

In some cases, the assembly process involves creating coordinating sets of wearable items 12 and garters. Users apply similar design principles and assembly techniques to smaller garter backers, creating matching or complementary wearable items. The modular approach established by decorative support assembly 10 facilitates the creation of coordinated decorative arrangements that maintain consistent aesthetic characteristics across multiple items.

The methods of assembly and use vary based on individual preferences, design complexity, and the specific components chosen for wearable item 12. Decorative support assembly 10 provides a flexible framework that accommodates a range of assembly techniques while facilitating the creation of visually appealing and structurally sound decorative wearable items. The guidance features incorporated into crown backer 14 and skirt backer 16 enable users to achieve professional results regardless of their experience level with decorative assembly operations.

The decorative support assembly 10 includes corresponding covers that are specifically configured to match each crown backer and skirt backer combination. Crown covers and skirt covers are manufactured in shapes and sizes that correspond to the specific configurations of crown backer 14, crown backer 100, heart-shaped crown backer 200, and crown backer 300, along with their respective skirt backers 16, 120, 220, and 320. The covers provide shape-specific concealment of fasteners 64 and other connecting mechanisms used during assembly operations.

For circular crown backer 14 and skirt backer 16, circular crown covers and rectangular skirt covers are provided to match the geometric configurations of the respective components. Texas-shaped crown backer 100 utilizes a corresponding Texas-shaped crown cover that follows the geographic outline of the crown backer, while skirt backer 120 employs a rectangular skirt cover that matches its dimensional characteristics. Heart-shaped crown backer 200 incorporates a heart-shaped crown cover that conforms to the romantic outline of the crown component, paired with an oval-shaped skirt cover that complements the horizontal oval configuration of skirt backer 220. Crown backer 300 in circular configuration utilizes circular crown covers in corresponding sizes, while skirt backer 320 employs rectangular skirt covers with rounded corners that match the profile of the skirt component.

The covers are manufactured in multiple size variations to accommodate the different dimensional options available for each crown backer and skirt backer configuration. The size-specific covers ensure proper coverage of all fastening hardware while maintaining the proportional relationships established by the underlying backer components. The covers provide aesthetic enhancement by presenting smooth, finished surfaces that conceal protruding fastener ends, staples, and other attachment hardware that may create visual irregularities on the rear surfaces of the assembled decorative arrangements.

The covers also provide safety benefits by eliminating user contact with sharp or protruding fastener elements that may cause injury during handling or wearing of the completed decorative items. The covers create protective barriers that prevent fastener ends from contacting skin or clothing, while maintaining the structural integrity and decorative characteristics of the assembled wearable items 12. The shape-specific and size-appropriate covers ensure comprehensive protection across all crown backer and skirt backer configurations while preserving the distinctive aesthetic characteristics of each decorative theme.

Decorative support assembly 10 is produced using various manufacturing methods to create visual indicia 28 and structural features of crown backer 14 and skirt backer 16. In some implementations, visual indicia 28 are printed onto the backer boards using digital printing techniques. Large-format inkjet printers are used to apply the radial lines, concentric circular guides 30, and other alignment guides directly onto cardstock or cardboard materials. This method allows for precise and consistent reproduction of the guiding indicia across multiple backer boards.

In some cases, offset printing techniques are employed for high-volume production of crown backer 14 and skirt backer 16. This method involves creating printing plates with the desired visual indicia 28 and transferring the ink onto crown planar base 22 and skirt flat base 50 through a series of rollers. Offset printing provides cost-effective production for large quantities of standardized backer designs.

Screen printing is utilized in some implementations, particularly for applying thicker inks or specialized coatings to crown backer 14 and skirt backer 16. This method involves pushing ink through a mesh stencil onto the backer material, allowing for the creation of raised or textured visual indicia 28 that provide both visual and tactile guidance for users during assembly of wearable item 12.

In some aspects, laser etching or engraving is employed to create visual indicia 28 on crown backer 14 and skirt visual indicia 56 on skirt backer 16. This process uses focused laser beams to remove material from the surface of crown planar base 22 or skirt flat base 50, creating precise and durable markings. Laser etching is particularly suitable for creating fine details or for use on materials that are not compatible with traditional printing methods.

The manufacturing process includes die-cutting operations to create the overall shape of crown backer 14 and skirt backer 16 and to form crown apertures 48 and skirt apertures 58 or detachable central portion 40. In some implementations, computerized cutting machines are used to achieve precise and consistent cuts across multiple backer boards. These machines are programmed to create various shapes and sizes of backers, including crown backer 100, heart-shaped crown backer 200, and crown backer 300, allowing for efficient production of different design options.

For crown backer 14 with detachable central portion 40, the manufacturing process involves creating weakened boundary 42 through perforating, scoring, or partial cutting techniques. In some cases, specialized die-cutting tools are used to create perforated lines that allow for easy removal of detachable central portion 40 while maintaining the structural integrity of peripheral portion 44 during initial assembly stages.

In some implementations, the manufacturing process incorporates lamination techniques to enhance the durability and water resistance of crown backer 14 and skirt backer 16. This involves applying a thin protective film over the printed or etched surface of front face 24 and front face 52, which helps preserve visual indicia 28 and skirt visual indicia 56 during use and storage.

For backers made from materials other than cardstock or cardboard, such as plastic or fabric-based options, injection molding or fabric printing techniques are employed. These methods allow for the integration of visual indicia 28 and structural features directly into crown planar base 22 and skirt flat base 50 during the forming process.

In some cases, the manufacturing process includes the application of adhesive elements or magnetic components to facilitate the attachment of first decorative articles 66 and second decorative articles 68 or the connection of crown backer 14 to skirt backer 16. These additional features are incorporated through automated assembly lines or manual application processes, depending on the complexity and volume of production.

The choice of manufacturing method depends on factors such as production volume, material selection, desired level of detail in visual indicia 28, and cost considerations. By utilizing a combination of these manufacturing techniques, decorative support assembly 10 is produced efficiently while maintaining the necessary precision and quality for effective use in creating wearable item 12.

In some implementations, decorative support assembly 10 incorporates specific dimensions and measurements to accommodate various design preferences and functional requirements. Crown backer 14 is available in a range of sizes to suit different mum styles and wearer preferences. Circular crown backer 14 is produced in diameters ranging from 6 inches to 12 inches, with common sizes including 8 inches, 10 inches, and 12 inches. Heart-shaped crown backer 200 is offered in similar size ranges, with width measurements typically corresponding to the diameter of circular backers.

The thickness of crown planar base 22 and skirt flat base 50 varies depending on the material used and the desired structural integrity. In some cases, cardstock backers have a thickness between 0.010 inches and 0.024 inches, while more rigid cardboard options range from 0.06 inches to 0.12 inches thick. Plastic or foam board alternatives are produced in thicknesses from 0.08 inches to 0.25 inches to provide enhanced durability.

Skirt backer 16 is designed with various length options to create different cascading effects for second decorative articles 68. Common skirt lengths include 12 inches, 18 inches, 24 inches, and 36 inches, measured from the bottom edge of crown backer 14 to the lowest point of skirt backer 16. The width of skirt flat base 50 is proportional to crown backer 14 size, typically ranging from 4 inches to 8 inches for standard designs, with wider options available for more elaborate arrangements.

In some aspects, the spacing of crown apertures 48 and skirt apertures 58 is standardized across different backer sizes to ensure compatibility. Alignment holes are positioned 0.5 inches from the edge of crown planar base 22 and skirt flat base 50 and spaced 1 inch apart. The diameter of these apertures ranges from 0.125 inches to 0.25 inches to accommodate various fastening methods using fasteners 64.

Detachable central portion 40 of crown backer 14 is sized proportionally to the overall backer dimensions. For an 8-inch diameter circular crown backer 14, detachable central portion 40 has a diameter of 3 inches to 4 inches. In heart-shaped crown backer 200, the detachable area is scaled accordingly to maintain visual balance.

Concentric circular guides 30 on crown backer 14 are spaced at regular intervals, such as 0.5 inches or 1 inch apart, depending on the overall size of crown planar base 22. Radial tick marks within visual indicia 28 are positioned every 15 degrees, 22.5 degrees, or 45 degrees to provide flexible guidance for first decorative articles 66 placement.

By offering a range of specific dimensions and measurements across the various components of decorative support assembly 10, users have the flexibility to create wearable item 12 tailored to their exact specifications while maintaining consistency and compatibility between crown backer 14 and skirt backer 16.

In some implementations, decorative support assembly 10 is packaged and distributed in ways that enhance user convenience and product protection. The packaging is designed to accommodate various backer sizes and shapes while providing clear visibility of the product contents.

Individual crown backer 14, skirt backer 16, and other backer components are enclosed in protective sleeves or envelopes made from clear plastic or recyclable materials. These sleeves help prevent damage to crown planar base 22 and skirt flat base 50 during shipping and handling while allowing customers to easily view the backer design and included visual indicia 28.

In some cases, sets of complementary backers such as matching crown backer 14 and skirt backer 16 components are bundled together in multi-pack configurations. These bundled sets provide users with coordinated components for creating complete decorative support assembly 10 arrangements. Heart-shaped crown backer 200 is packaged with corresponding skirt backer 220, while Texas-shaped crown backer 100 is bundled with skirt backer 120 to provide themed assembly options.

Decorative support assembly 10 is offered in themed collections or seasonal assortments. For example, holiday-specific backer designs or school color-coordinated sets are packaged together to appeal to different market segments or event types. Crown backer 300 in various sizes is grouped with appropriately sized skirt backer 320 to create size-specific packaging options.

Retail packaging for decorative support assembly 10 includes hanging tags or display boxes suitable for pegboard or shelf presentation. These packaging options incorporate colorful graphics and product images to attract customer attention and communicate key features of the backer system, including the guidance provided by concentric circular guides 30 and quadrant guides 38.

In some aspects, the packaging includes QR codes or web links that direct users to online resources such as video tutorials, design inspiration galleries, or additional product information. This integration of physical packaging with digital content enhances the overall user experience and provides added value for assembly of wearable item 12.

Decorative support assembly 10 is distributed through various channels, including craft supply stores, party goods retailers, and online marketplaces. In some implementations, customized or bulk ordering options are available for schools, organizations, or event planners looking to purchase larger quantities of specific backer designs.

Packaging for bulk orders utilizes more economical and space-efficient designs, such as stacked arrangements of backers separated by protective sheets. This approach reduces packaging waste while still ensuring product integrity of crown backer 14 and skirt backer 16 during shipping and storage.

In some cases, decorative support assembly 10 is offered as part of curated craft kits or subscription boxes that include complementary decorative elements and assembly materials. These comprehensive packages provide users with all the necessary components to create complete wearable item 12 projects, including first decorative articles 66 and second decorative articles 68.

The packaging and distribution strategies for decorative support assembly 10 are adaptable to accommodate evolving market trends, customer preferences, and sustainability considerations. This flexibility allows for ongoing refinement of the product presentation and delivery methods to best serve the needs of users and retailers.

Advantages of the present invention address several shortcomings of prior art support backers for decorative corsages such as homecoming mums and garters. In some aspects, decorative support assembly 10 provides significant improvements over existing plain backing designs, transforming the backing itself from a simple structural support into an instructional assembly system that guides users to achieve professional, symmetrical results without guesswork, trial-and-error, or specialized tools.

One advantage of the present invention is the incorporation of a systematic visual guidance system integrated into the decorative backing supports through visual indicia 28 to help mum makers position first decorative articles 66 and second decorative articles 68 around crown backer 14. The alternating radial line pattern comprising solid and dotted radial lines allows users to create layered decorative arrangements by positioning different elements on alternating line types, with solid lines for first layer elements and dotted lines for second layer elements. This systematic guidance enables repeatable, symmetrical assembly of complex decorative items, addressing a common challenge in creating balanced and visually appealing designs. Prior art plain backers often lack such guidance, requiring users to estimate spacing and positioning, leading to uneven, unprofessional results and wasted materials.

Another benefit of decorative support assembly 10 is the inclusion of multi-style concentric circular guides 30 with different line styles including stitched, solid, and dotted lines that provide distinct visual cues for positioning decorative elements at specific radial distances from crown planar base 22. This feature helps users maintain a clean and professional appearance by ensuring first decorative articles 66 are positioned at appropriate distances from the backer's perimeter with consistent, balanced placement. In contrast, traditional plain backers lack clear boundaries and systematic guidance, potentially resulting in overcrowded edges, uneven margins, and unprofessional appearance.

The present invention also provides integrated access features through detachable central portion 40 with inner slits strategically positioned to allow standard staplers to reach interior areas of crown backer 14 for inserting a regularly sized fastening tool 62. This design consideration solves the technical problem of requiring expensive specialized tools by allowing decorative elements to be easily attached to crown backer 14 without the need for long-reach staplers. Prior art plain backers often present challenges when attaching decorative elements, as standard staplers are too short to reach desired attachment points comfortably. This limitation leads to awkward assembly techniques and potential damage to delicate materials.

A notable advantage of decorative support assembly 10 is the modular precision connection system featuring square-shaped crown apertures 48 on crown backer 14 that align with corresponding square-shaped skirt apertures 58 on skirt backer 16. This feature enables precise, repeatable connection between crown and skirt components using fasteners 64, streamlining the assembly process and ensuring consistent alignment. Traditional plain backers lack such precision alignment features, making it difficult to achieve proper positioning and secure connections between different sections of wearable item 12.

For irregularly shaped crown backers, such as crown backer 100 in the shape of the state of Texas, heart-shaped crown backer 200, or other configurations including quadrilaterals, bows, butterflies, paws, or horses, the present invention incorporates first apertures 108 or first apertures 210 strategically positioned to accommodate flower stems while maintaining the intended shape. This systematic template design allows the resulting wearable item 12 to retain its recognizable shape more effectively than prior art plain backers. Traditional irregularly shaped backers lack guidance for flower placement, potentially leading to distorted or unrecognizable final shapes that obscure the intended design.

Some embodiments of decorative support assembly 10 provide crown backer 14 and skirt backer 16 that transform the backing from a plain structural support into a comprehensive instructional craft system, while other embodiments offer visual indicia 28 and skirt visual indicia 56 through various marking techniques. These variations cater to different user preferences and skill levels, enhancing the overall accessibility of mum-making techniques by providing systematic guidance that ensures consistent results.

The present invention also addresses industry needs in the specialized crafting market for homecoming mums by providing skirt backer 16 with appropriate widths and lengths that accommodate current design trends, unlike some prior art plain support backers that lack systematic guidance features. This adaptability to evolving styles, combined with the integrated instructional system, enhances the versatility and longevity of decorative support assembly 10.

Another advantage of decorative support assembly 10 is its potential to eliminate the need for long staplers when attaching ribbon loops as first decorative articles 66. By incorporating weakened boundary 42 with inner slits that allow for easier stapling with standard fastening tool 62, the invention decreases the likelihood of luster ribbon becoming wrinkled during assembly. This improvement leads to a more polished and professional appearance in the finished wearable item 12 while reducing the cost and complexity of required tools.

These advantages, along with others, demonstrate how decorative support assembly 10 transforms decorative backing from a plain structural support into a template and instruction system combined into one physical product. The systematic visual guidance system enables repeatable, symmetrical assembly of complex decorative corsages, providing a comprehensive solution to many challenges faced by mum makers in this specialized crafting market while facilitating the creation of visually appealing and structurally sound decorative wearable items 12.

As used herein, the term “backer board” may refer to a support structure used as a foundation for creating decorative mums or garters. A backer board may be made from materials such as cardboard, cardstock, foam board, plastic, or other rigid or semi-rigid materials, and may come in various shapes and sizes. In the context of the present invention, both the crown backer and skirt backer function as backing supports that provide structural foundations for their respective portions of the decorative support assembly. The crown backer serves as a backing support for the upper decorative portion, while the skirt backer acts as a backing support for the lower cascading section of the wearable item.

The term “crown backer” may refer to a backer used for the upper or main portion of a decorative mum assembly. Crown backers may come in shapes such as circular, heart-shaped, Texas-shaped, butterfly-shaped, or other geometric or custom forms.

The term “skirt backer” or “secondary backer board” may refer to a backer used for the lower portion of a decorative mum assembly, typically extending downward from the crown portion. Skirt backers may be rectangular, oval, or other elongated shapes.

The term “visual indicia” may refer to markings, lines, patterns, or other visual cues on a backer that provide guidance for positioning decorative elements, including radially arranged tick marks, alphanumeric quadrant labels, alignment zones, or concentric circular guides.

The term “alignment apertures” may refer to holes or openings in backers used to align and connect different portions of a mum assembly, such as connecting a crown backer to a skirt backer, or for securing decorative elements or attaching additional layers.

The term “detachable central portion” may refer to a section of a backer that can be partially or fully detached along a weakened boundary to provide easier access for attaching decorative elements or to create an opening for attaching a central decorative element.

The term “weakened boundary” may refer to a perforated line, a scored line, or a partially cut line that defines a detachable portion of a backer board.

The term “mechanical fasteners” may refer to zip ties, twist ties, or string used to couple backer components together.

“Decorative elements” may include any ornamental components used in creating a mum or garter, such as ribbons, flowers, trinkets, feathers, or other embellishments.

The term “homecoming mum” may refer to a large, elaborate corsage traditionally worn during homecoming events, particularly in certain regions of the United States.

“Garter” may refer to a smaller decorative item, similar to a mum, typically worn around the arm or leg during homecoming events.

The term “modular multi-part construction” may refer to a system where multiple backer components can be combined to create customized decorative arrangements.

The term “instructional craft system” may refer to the combination of visual indicia and structural features that guide users in creating symmetrical and balanced decorative arrangements.

While the invention has been described in terms of exemplary embodiments, it is to be understood that the words that have been used are words of description and not of limitation. As is understood by persons of ordinary skill in the art, a variety of modifications can be made without departing from the scope of the invention defined by the following claims, which should be given their fullest, fair scope.

What is claimed is:

1. A decorative support assembly for constructing a wearable item, comprising:
a backer board having a front surface and a rear surface; and
a plurality of visual indicia printed or etched on the front surface of the backer board for enabling repeatable and symmetrical placement of decorative elements, the indicia including at least one of:
(a) radially arranged tick marks;
(b) alphanumeric quadrant labels; or
(c) alignment zones marked for symmetrical placement of ribbons or embellishments;
wherein the backer board includes a detachable central portion defined by a weakened boundary that provides a visual placeholder during layout and can be selectively removed to create an opening for attaching a central decorative element or retained for layered presentation.

2. The decorative support assembly of claim 1, wherein the visual indicia further include concentric circular guides for positioning decorative elements at varying radial distances from a center of the backer board, thereby providing instructional guidance for decorative placement, and wherein the concentric circular guides comprise different line styles including at least two of stitched lines, solid lines, and dotted lines to distinguish between different placement zones.

3. The decorative support assembly of claim 1, wherein the weakened boundary comprises a perforated line, a scored line, or a partially cut line.

4. The decorative support assembly of claim 1, further comprising a plurality of alignment apertures formed through the backer board for securing decorative elements or attaching additional layers, and wherein the backer board includes inner slits positioned to allow insertion of a standard stapler for attaching decorative elements without requiring specialized long-reach staplers.

5. The decorative support assembly of claim 4, wherein the alignment apertures are configured to receive mechanical fasteners for coupling the backer board to a secondary backer board, enabling a modular multi-part construction, and wherein at least some of the alignment apertures are square-shaped to provide precise alignment with corresponding square apertures on the secondary backer board.

6. The decorative support assembly of claim 1, wherein the backer board is formed from a material selected from the group consisting of cardboard, cardstock, foam board, and plastic.

7. The decorative support assembly of claim 1, wherein the detachable central portion remains partially attached to the backer board at one or more connection points to allow folding back of the central portion while maintaining structural integrity.

8. A modular decorative backer system for a wearable item comprising:
a crown backer and a skirt backer, each comprising a generally planar base with a front face and a rear face, wherein the crown backer and skirt backer are functionally distinct components that promote ease of assembly and customization; and
a plurality of alignment apertures formed through each backer;
wherein the crown backer is removably coupled to the skirt backer through at least two of the alignment apertures using mechanical fasteners, allowing decorative elements to be independently arranged, secured, and layered in stages; and
wherein the crown backer includes a detachable central portion defined by a weakened boundary that can be selectively removed or retained, providing functional flexibility without additional parts.

9. The modular decorative backer system of claim 8, wherein the crown backer includes visual indicia printed or etched on its front face for guiding placement of decorative elements, enabling repeatable and symmetrical decorative arrangements.

10. The modular decorative backer system of claim 9, wherein the visual indicia comprise at least one of radially arranged tick marks, alphanumeric quadrant labels, or alignment zones marked for symmetrical placement of ribbons, forming an instructional craft system, and wherein the radially arranged tick marks alternate between solid lines and dotted lines to facilitate layered placement of decorative elements.

11. The modular decorative backer system of claim 9, wherein the visual indicia further include concentric circular guides for positioning decorative elements at varying radial distances from a center of the crown backer, and wherein the concentric circular guides comprise different line styles including at least two of stitched lines, solid lines, and dotted lines.

12. The modular decorative backer system of claim 8, wherein the detachable central portion provides a visual placeholder during layout and can be selectively removed to create an opening for attaching a central decorative element or retained for layered presentation.

13. The modular decorative backer system of claim 8, wherein the mechanical fasteners comprise zip ties, twist ties, or string.

14. The modular decorative backer system of claim 8, wherein the skirt backer includes additional alignment apertures for attaching cascading ribbons or decorations, enabling multi-layered decorative arrangements, wherein the crown backer includes inner slits positioned to allow insertion of a standard stapler for attaching decorative elements, and wherein the alignment apertures include square-shaped apertures for precise alignment between the crown backer and skirt backer.

15. A decorative crafting backer comprising:
a planar board having a central portion and a peripheral portion;
wherein the central portion is defined by a weakened boundary and is selectively detachable from the peripheral portion to expose an opening, providing a visual placeholder during layout and offering user choice between removing the center for open designs or leaving it intact for layered presentation; and
wherein the peripheral portion includes alignment indicia printed or etched on its surface for positioning decorative components in radial arrangement relative to the opening, enabling repeatable and symmetrical decorative placement.

16. The decorative crafting backer of claim 15, wherein the alignment indicia comprise radially arranged tick marks spaced at regular angular intervals around the peripheral portion, forming part of an instructional craft system.

17. The decorative crafting backer of claim 16, wherein the alignment indicia further comprise concentric circular guides for positioning decorative components at varying radial distances from the opening, providing instructional guidance for decorative placement.

18. The decorative crafting backer of claim 15, wherein the weakened boundary comprises a perforated line, a scored line, or a partially cut line.

19. The decorative crafting backer of claim 15, further comprising a plurality of alignment apertures formed through the peripheral portion for securing decorative components or attaching additional layers, enabling a modular multi-part construction, wherein the peripheral portion includes edge guidance lines positioned at predetermined distances from a perimeter of the planar board, the edge guidance lines providing inner and outer boundary options for placement of decorative elements.

20. The decorative crafting backer of claim 19, wherein the alignment apertures are configured to receive mechanical fasteners for coupling the decorative crafting backer to a secondary backer, allowing decorative elements to be independently arranged, secured, and layered in stages.
